(19) United States
(12) Patent Application Publication
(10) Pub. No.: US 2026/0337102 A1
(43) Pub. Date: Oct. 29, 2026

(54) SYSTEM AND APPARATUS FOR RAPID CARBONATION OF RECYCLED CONCRETE AGGREGATES (RCA)

(71) Applicant: Talon Innovations, LLC, Omaha, NE (US)

(72) Inventor: Christopher H. Hawkins, Omaha, NE (US)

(73) Assignee: Talon Innovations, LLC, Omaha, NE (US)

(21) Appl. No.: 19/660,942

(22) Filed: Apr. 28, 2026

Related U.S. Application Data
(60) Provisional application No. 63/796,311, filed on Apr. 28, 2025.

(51) Int. Cl. C04B 20/02; C04B 18/167; B01J 8/00

(52) U.S. Cl. CPC C04B 20/0232; C04B 18/167; B01J 8/008; B01J 2208/00637

(57) ABSTRACT

The present disclosure is directed towards a system and apparatus for rapid carbonation of recycled concrete aggregates (RCA) for commercial applications. In some aspects, the apparatus includes a treatment tank having a hermetically sealable chamber with a first opening to receive untreated RCA and a second opening to expel treated RCA. The chamber may be sealed and pressurized with carbon dioxide gas supplied through an inlet port fluidly connected to a carbon dioxide source to accelerate carbonation of the recycled concrete aggregates within the sealed chamber. Internal components are configured to distribute the carbon dioxide gas evenly throughout the chamber. Sensors may also be incorporated to measure temperature, pressure, and relative humidity inside the chamber. The system and apparatus may further include a controller configured to automatically monitor and adjust treatment conditions, or alternatively, to display treatment conditions to an operator for manual monitoring and adjustment.

### CROSS-REFERENCE TO RELATED APPLICATIONS

This application claims priority under 35 U.S.C. § 119 to U.S. Provisional Application No. 63/796,311, filed Apr. 28, 2025, which is hereby incorporated by reference in its entirety.

### FIELD OF INVENTION

The present disclosure relates to treating hardened concrete for subsequent reuse in the production of new concrete or asphalt. More particularly, the present disclosure relates to a system and apparatus for rapid carbonation of recycled concrete aggregates (RCA) by pressurizing a sealed treatment chamber with carbon dioxide (CO₂) gas to accelerate the carbonation treatment process and improve the mechanical and chemical properties of the RCA.

### BACKGROUND

Concrete is one of the most widely used construction materials in the world. As concrete structures reach the end of their useful life, they are often demolished, generating substantial quantities of hardened concrete as a waste product. Traditional concrete recycling typically involves crushing and screening this hardened concrete to form RCA.

RCA would optimally be used as a replacement for natural stone aggregates in high-value construction applications, including new concrete production, asphalt pavement, structural fill, and road base materials. However, as compared to natural stone aggregates, RCA inherently has reduced mechanical properties because of residual cement paste and weatherization. Such reduced mechanical properties have historically limited the use of RCA in the production of new concrete and asphalt. For example, many jurisdictions restrict the use of RCA in concrete and asphalt road construction because high proportions can detrimentally impact a roadway's strength and longevity. There are also environmental concerns associated with using RCA in new concrete or asphalt because of its potential to leach heavy metals and its inherent alkaline chemical properties, which may contaminate groundwater and surrounding watersheds. These alkaline chemical properties may further prevent the use of RCA in certain applications, such as bedding material for underground piping, where elevated pH levels in water leachate may be undesirable or prohibited.

Carbonation is a process whereby carbon dioxide reacts with calcium hydroxide present in the residual cement paste of RCA to form calcium carbonate. This reaction can improve the mechanical properties of RCA by creating new calcium carbonate minerals within existing pores and upon the surface of the aggregate. Carbonation may also reduce the alkalinity of RCA, potentially addressing some environmental concerns associated with its use.

While carbonation of RCA has been explored, existing approaches may face challenges related to processing efficiency, scalability, and the ability to control treatment conditions. For instance, ambient carbonation processes require extended treatment times, while other approaches may involve complex equipment configurations or may not be well-suited for large-scale commercial applications. Additionally, loading and unloading bulk aggregate materials into and out of treatment vessels presents practical challenges that may affect throughput and operational efficiency.

Therefore, improved systems and apparatuses for treating hardened concrete that provide opportunities for recycling and reuse, while addressing the mechanical and environmental limitations of untreated RCA, is needed on a commercial scale.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an apparatus for treating RCA includes a treatment tank with a hermetically sealable chamber having first and second openings and sealable doors for receiving untreated RCA and discharging treated RCA. The chamber may be sealed and pressurized with carbon dioxide gas supplied through an inlet port fluidly connected to a carbon dioxide source to accelerate carbonation of the recycled concrete aggregates within the sealed chamber. An outlet port may be configured to remove excess carbon dioxide gas from the chamber. Internal components distribute the carbon dioxide gas throughout the chamber, while sensors measure temperature, pressure, and humidity.

According to another aspect of the present disclosure, a system for treating RCA is provided. The system may include first and second conveyance devices for transporting untreated and treated RCA, respectively. The system may further include an apparatus for receiving the untreated RCA from the first conveyance device and for discharging the treated RCA to the second conveyance device. The apparatus may comprise a treatment tank with a hermetically sealable chamber having first and second openings with sealable doors. A carbon dioxide source may be provided to supply carbon dioxide to the system. In some instances, a vaporizer may be provided to convert liquid carbon dioxide into gaseous carbon dioxide for introduction into the chamber. The chamber may be sealed and pressurized with the gaseous carbon dioxide supplied through an inlet port to accelerate carbonation of the RCA within the sealed chamber. Internal components may distribute the carbon dioxide gas throughout the chamber, and a controller may monitor and provide for adjustment of treatment conditions within the chamber. The system may also include a support assembly designed to maintain the treatment tank at a designated position relative to the conveyance devices.

According to a further aspect of the present disclosure, an apparatus for treating RCA includes a treatment tank with a hermetically sealable chamber, first and second openings with sealable doors, and inlet and outlet ports. A closed-loop gas circulation system may be provided that draws carbon dioxide gas from the chamber through a dehumidification stage and returns it to the chamber, maintaining pressurized conditions while controlling humidity. Sensors may be incorporated into the apparatus to measure chamber conditions, and quality control equipment to monitor untreated RCA properties. A controller may automatically adjust treatment parameters based on feedstock properties and terminate the process based on monitored temperature, humidity, and pressure conditions to prevent calcium silicate hydrate (C-S-H) conversion, or alternatively, the controller may monitor such parameters and provide relevant information to an operator for manual adjustment of treatment parameters or manual termination of the process.

The foregoing general description of the illustrative embodiments and the following detailed description thereof are merely exemplary aspects of the teachings of this disclosure and are not restrictive.

### OBJECTS, FEATURES, AND ADVANTAGES

It is a principal object, feature, and advantage of the present disclosure to overcome the aforementioned deficiencies in the art and provide an improved system and apparatus for treating hardened concrete that provide opportunities for recycling and reuse as opposed to being sent to landfills or stockpiles.

Another object, feature, and advantage of the present disclosure is to provide an improved system and apparatus for treating hardened concrete that significantly improves the inherent mechanical and chemical properties thereof, including increased compressive strength, improved freeze/thaw and abrasion resistance, increased specific gravity, and reduced alkalinity, to permit use as a high-quality replacement for natural stone aggregates in new concrete and asphalt construction projects as well as for pipe-bedding applications.

Yet another object, feature, and advantage of the present disclosure is to provide an improved system and apparatus for treating hardened concrete that produces treated RCA suitable for use in pipe bedding and other applications where untreated RCA may be unsuitable due to its inherently high alkalinity. The carbonation treatment may reduce the pH of water leachate from the treated RCA, thereby enabling its use in applications such as pipe bedding, engineered backfill, and base course materials where lower leachate pH may be required to protect underground infrastructure, surrounding soils, and groundwater quality.

A further object, feature, and advantage of the present disclosure is to provide an improved system and apparatus for treating hardened concrete that is environmentally beneficial by sequestering carbon dioxide within the RCA, thereby providing opportunities to mitigate harmful greenhouse gas emissions while simultaneously reducing the volume of construction waste sent to landfills or stockpiles.

A still further object, feature, and advantage of the present disclosure is to provide an improved system and apparatus for treating hardened concrete that seals a chamber and pressurizes the sealed chamber with carbon dioxide gas to achieve accelerated or rapid carbonation of the RCA, substantially reducing treatment times as compared to ambient carbonation processes.

Another object, feature, and advantage of the present disclosure is to provide an improved system and apparatus for treating hardened concrete that is scalable for mass-scale commercial applications, capable of treating at least 10 tons of RCA per treatment cycle, thereby addressing the throughput limitations of existing carbonation approaches.

Yet another object, feature, and advantage of the present disclosure is to provide an improved system and apparatus for treating hardened concrete that utilizes a pressurized environment to achieve rapid carbonation treatment within approximately 4 to 12 hours, representing a significant reduction in treatment time as compared to ambient carbonation approaches.

A further object, feature, and advantage of the present disclosure is to provide an improved system and apparatus for treating hardened concrete that is designed for efficient use of carbon dioxide gas exposure through a plurality of internal ducts configured to circulate carbon dioxide gas throughout the treatment tank along with a blower or compressor to fully expose the recycled concrete aggregates therein, and further includes an outlet port for recovering and recycling excess carbon dioxide gas in the system.

A still further object, feature, and advantage of the present disclosure is to provide an improved system and apparatus for treating hardened concrete that is designed for efficient relative humidity control within the sealed chamber to optimize carbonation reaction conditions.

Another object, feature, and advantage of the present disclosure is to provide an improved system and apparatus for treating hardened concrete that includes hermetically sealable doors at first and second openings of the treatment tank, enabling the chamber to maintain pressurization during the carbonation treatment process while facilitating efficient loading and unloading of bulk aggregate materials.

Yet another object, feature, and advantage of the present disclosure is to provide an improved system and apparatus for treating hardened concrete that includes a controller configured to monitor and provide for the adjustment of treatment conditions within the treatment tank until a predetermined condition is met, thereby ensuring consistent and repeatable carbonation treatment results.

A further object, feature, and advantage of the present disclosure is to provide an improved system and apparatus for treating hardened concrete that is configured for integration with conveyance devices to facilitate continuous loading of untreated RCA and unloading of treated RCA, thereby improving operational efficiency and throughput for commercial applications.

A still further object, feature, and advantage of the present disclosure is to provide an improved system and apparatus for treating hardened concrete that includes a controller configured to monitor temperature build, humidity build, and pressure drop within the treatment tank and to detect a plateau condition indicating the transition from beneficial calcium hydroxide carbonation to undesirable C-S-H conversion, thereby providing for automatic termination of the treatment process upon detection of the plateau condition, or alternatively, providing an alert or notification to an operator for manual termination of the treatment process, at the optimal point to maximize beneficial carbonation while preserving the structural integrity of the C-S-H minerals within the RCA.

Another object, feature, and advantage of the present disclosure is to provide an improved system and apparatus for treating hardened concrete that enables efficient use and recycling of carbon dioxide gas through a daisy-chain array configuration of multiple treatment apparatuses, whereby carbon dioxide gas expelled from a first apparatus at a first pressure may be directed to a second apparatus operating at a lower pressure. In some instances, the system and apparatus includes a pressurized holding tank for storing recovered carbon dioxide gas for subsequent reuse, thereby creating a comprehensive carbon dioxide management system that minimizes waste and reduces operating costs.

Yet another object, feature, and advantage of the present disclosure is to provide an improved system and apparatus for treating hardened concrete that reduces the concentration of alkali hydroxides within the residual cement paste of the recycled concrete aggregates through rapid, pressurized carbonation treatment, thereby mitigating the potential for alkali-silica reaction (ASR) and enabling the use of treated RCA in new concrete applications where ASR susceptibility may otherwise be a concern.

A further object, feature, and advantage of the present disclosure is to provide an improved system and apparatus for treating hardened concrete that includes a closed-loop gas circulation system for circulating carbon dioxide gas and controlling relative humidity within the sealed chamber, maintaining the pressurized carbon dioxide atmosphere while simultaneously controlling relative humidity levels without venting and replacing carbon dioxide gas during humidity adjustment.

A still further object, feature, and advantage of the present disclosure is to provide an improved system and apparatus for treating hardened concrete that is configured for mobile deployment on a trailer chassis, truck frame, or custom wheeled apparatus. In some instances, hydraulically operated jacks may be incorporated and configured to tilt the treatment tank to facilitate gravity-assisted unloading of treated RCA, thereby enabling the apparatus to be transported between different work sites for on-site carbonation treatment.

Another object, feature, and advantage of the present disclosure is to provide an improved system and apparatus for treating hardened concrete that utilizes a transition to vacuum conditions within the treatment tank as a real-time indicator that carbonation of the recycled concrete aggregates is substantially complete, enabling the controller to optimize treatment duration for each batch based on actual carbonation uptake rather than estimated treatment times.

Yet another object, feature, and advantage of the present disclosure is to provide an improved system and apparatus for treating hardened concrete that includes quality control equipment configured to characterize the recycled concrete aggregates prior to treatment, wherein the controller may automatically adjust treatment parameters including pressure, treatment time, and relative humidity based on measured feedstock properties, or alternatively, the controller may monitor such treatment parameters and provide relevant information to an operator for manual adjustment of treatment parameters, thereby optimizing treatment conditions for each batch and improving treatment consistency.

Other objects, features, or advantages of this disclosure will become apparent from the following detailed description and claims, taken in conjunction with the accompanying drawings that set forth, by way of illustration and example and without limitation, certain aspects of this disclosure. No single aspect need provide each and every object, feature, or advantage. Thus the present disclosure is not to be limited to or by these objects, features, and advantages.

### BRIEF DESCRIPTION OF FIGURES

Non-limiting and non-exhaustive examples are described with reference to the following figures.

FIG. 1 illustrates a perspective view of a system for treating hardened concrete, according to aspects of the present disclosure.

FIG. 2 illustrates a perspective view of an apparatus for treating hardened concrete in a vertical orientation configuration, according to aspects of the present disclosure.

FIG. 3 illustrates a perspective view of the apparatus of FIG. 2 in a horizontal orientation configuration, according to aspects of the present disclosure.

FIG. 4 illustrates a perspective view of a hinged door configuration at a first opening of the apparatus of FIG. 2, according to aspects of the present disclosure.

FIG. 5 illustrates a perspective view of a slide gate door configuration at a first opening of the apparatus of FIG. 3, according to aspects of the present disclosure.

FIG. 6 illustrates a perspective view of a hinged door configuration at a second opening of the apparatus of FIG. 2, according to aspects of the present disclosure.

FIG. 7 illustrates a perspective view of a slide gate door configuration at a second opening of the apparatus of FIG. 3, according to aspects of the present disclosure.

FIG. 8 illustrates a side view of the apparatus of FIG. 2, according to aspects of the present disclosure.

FIG. 9 illustrates a front cross-sectional view of the apparatus of FIG. 2, according to aspects of the present disclosure.

FIG. 10 illustrates a perspective cross-sectional view of the apparatus of FIG. 2, according to aspects of the present disclosure.

FIG. 11 illustrates a top cross-sectional view of the apparatus of FIG. 2, according to aspects of the present disclosure.

FIG. 12 illustrates a schematic diagram of a closed-loop gas circulation system of the apparatus of FIG. 2, according to aspects of the present disclosure.

FIG. 13 illustrates a schematic diagram of a daisy-chain array configuration of multiple apparatuses of FIG. 2, according to aspects of the present disclosure.

FIG. 14 illustrates a block diagram of a controller system of the apparatus of FIG. 2, according to aspects of the present disclosure.

FIG. 15 illustrates a perspective view of the apparatus of FIG. 2 in a mobile trailer-mounted configuration with tilt-unloading jacks, according to aspects of the present disclosure.

### DETAILED DESCRIPTION

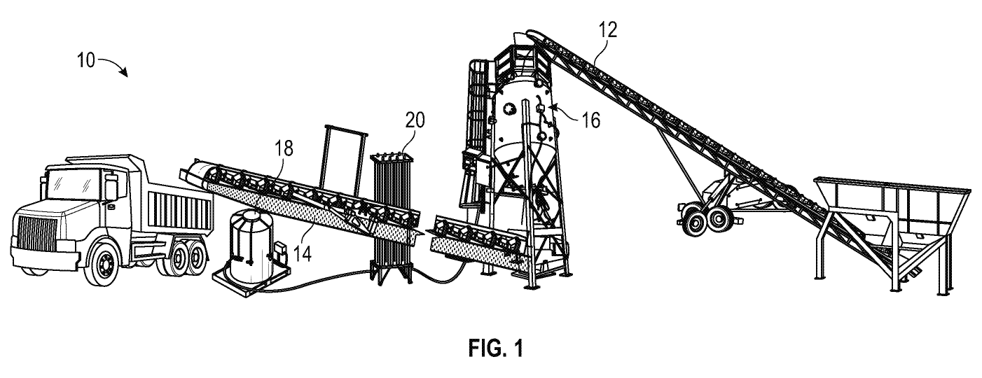

Referring generally to FIGS. 1-15, the present disclosure relates to a system and an apparatus for treating hardened concrete for subsequent recycling in the production of new concrete or asphalt. In particular, the system and apparatus are configured to treat RCA in a pressurized environment utilizing carbon dioxide gas for rapid carbonation. The system and apparatus may further provide for batch processing of the RCA, wherein untreated RCA is loaded into the apparatus, the apparatus is sealed and pressurized with carbon dioxide gas for a defined period to treat the RCA, the treated RCA is unloaded from the apparatus, and the cycle repeated.

Carbonation is a process whereby carbon dioxide reacts with calcium hydroxide (Ca(OH)₂) present in the residual cement paste of RCA to form calcium carbonate (CaCO₃) and water (H₂O). Carbonation of the RCA may change the proportion of constituting minerals in the RCA, increasing the percentage of calcium carbonate as a result of reactions between calcium hydroxide and calcium silicate hydrate (C-S-H) and carbon dioxide. The carbonation process may strengthen the RCA by creating solid calcium carbonate minerals that fill pores and cracks within, and coat the surface of, the aggregate. Carbonation may also reduce the alkalinity of RCA, addressing environmental concerns associated with the use of untreated RCA in groundwater conditions, pipe bedding, and other applications where high alkalinity may be undesirable. The use of gaseous carbon dioxide is particularly suited for treating RCA because the gas can penetrate the existing pore structures and microcracks present in the already-cured aggregate material.

The present disclosure is directed toward treating RCA with gaseous carbon dioxide, which is fundamentally different from prior art approaches that utilize carbon dioxide to cure wet or freshly mixed concrete. Such prior art carbon dioxide curing techniques are applied during the initial hydration and setting process of wet concrete, where the carbon dioxide interacts with the cementite matrix as it forms. In contrast, the present disclosure treats RCA that has already undergone complete hydration and has been in service, often for decades, before being demolished and crushed. RCA presents different chemical and physical characteristics than wet concrete, including established pore structures, weathered surfaces, and residual cement paste that has already cured. The carbonation treatment of RCA therefore requires significantly different processing conditions and apparatus configurations than those used for curing wet concrete.

The present disclosure is also fundamentally different from prior art approaches that utilize ambient carbonation processes to treat RCA, which require extended treatment times to achieve sufficient carbonation. Prior art ambient carbonation processes may require treatment times measured in days, weeks, or even months. The system and apparatus of the present disclosure address these limitations by sealing the chamber and pressurizing the sealed chamber with carbon dioxide gas to accelerate the carbonation treatment process. The pressurized gaseous treatment environment may increase the rate of carbonation reactions and improve penetration of carbon dioxide gas into the pore structures of the RCA, enabling the apparatus and system to achieve effective carbonation treatment within approximately 4 to 12 hours at elevated pressures. This represents a significant reduction in treatment time as compared to ambient carbonation approaches, enabling multiple treatment cycles per day and commercially viable throughput volumes suitable for large-scale commercial operations where processing efficiency and throughput are critical considerations. The combination of elevated pressure, active gas circulation through the internal duct system, controlled relative humidity, and optimized treatment conditions within the sealed chamber collectively contribute to the accelerated carbonation rate.

The RCA to be treated by the system and apparatus of the present disclosure may comprise varying diameter sizes. In some aspects, the RCA may comprise a diameter ranging between approximately 1/4 inch to approximately 1 inch. In other aspects, the RCA may comprise a diameter smaller than approximately 1/4 inch. In further aspects, the RCA may comprise a diameter greater than approximately 1 inch. In still further aspects, the RCA may comprise a diameter ranging between approximately 1/4 inch to approximately 1.5 inches. In yet further aspects, the RCA may comprise aggregates of varying diameter sizes having a mixed gradation to meet concrete or Asphalt Cement Concrete (ACC) specifications. The overall size of the RCA may be selected for effective and efficient treatment during operation of the system and apparatus while maintaining a gradation consistent with concrete and asphalt mix design parameters. As a non-limiting example, the hardened concrete contemplated by the present disclosure may be generated from the demolition of concrete structures such as commercial buildings, residential buildings, bridges and civil structures, highways, streets, sidewalks, driveways, airport runways, and parking facilities. The hardened concrete may then be crushed and screened to a desired aggregate size to form RCA suitable for treatment by the system and apparatus disclosed herein.

The system and apparatus may be configured for rapid carbonation of RCA in mass-scale commercial applications. In some aspects, the chamber may have a volume ranging between approximately 400 cubic feet and 4,600 cubic feet. In other aspects, the treatment tank may be configured to treat between approximately 10 tons and 230 tons of RCA per treatment cycle. The system and apparatus further address challenges typically associated with handling bulk aggregate materials that utilize a single door or opening for both loading and unloading operations. In such instances, manual handling of RCA is required through the use of baskets, shovels, or similar labor-intensive methods that limit throughput and are impractical for commercial-scale operations. In contrast, the dual-opening configuration of the present disclosure, combined with frustoconical tapered sidewalls, enables gravity-assisted flow-through processing where untreated RCA may be loaded through the first opening at the upper portion and treated RCA may be discharged through the second opening at the lower portion, substantially reducing handling time and enabling continuous or semi-continuous processing cycles for mass-scale commercial applications.

While certain aspects of the present disclosure are shown and described herein, it is understood that such aspects are merely exemplary. The present disclosure is not intended to be limited to these specific aspects and may encompass other aspects or embodiments. Therefore, specific system and apparatus details disclosed herein are not to be interpreted or inferred as limiting, but merely as a basis for the claims and as a representative basis for teaching one skilled in the art how to make and use the disclosed subject matter.

It must further be noted that the singular terms "a," "an," and "the" as used herein may include plural referents unless the context clearly dictates otherwise. Thus, for example, a reference to "an element" is a reference to one or more elements and includes equivalents thereof known to those skilled in the art. Similarly, for another example, a reference to "a step" or "a means" is a reference to one or more steps or means and may include sub-steps and subservient means.

All words of approximation as used in the present disclosure and claims should be construed to mean "approximate," rather than "perfect" or "exact," and may be used as a modifier to any other word, number, quantity, quality, value, or specified parameter. Words of approximation, include, but are not limited to terms such as "about," "approximately," "around," "almost," "generally," "largely," "essentially," "substantially," etc. As used herein, in some aspects, the terms "about" or "approximately" when preceding a numerical value may indicate the value plus or minus a range of .1, .2, .3, .4 or .5 inches. In other aspects, the terms "about" or "approximately" when preceding a numerical value may indicate the value plus or minus a range of 1, 2, 3, 4 or 5 inches. In further aspects, the terms "about" or "approximately" when preceding a numerical value may indicate the value plus or minus a range of 1, 2, 3, 4 or 5 feet. In still further aspects, the terms "about" or "approximately" when preceding a numerical value indicates the value plus or minus a range of 10, 20, 30, 40 or 50 cubic feet (ft³). In some aspects, the terms "about" or "approximately" when preceding a numerical value may indicate the value plus or minus a range of 1, 2, 3, 4 or 5° F. In other aspects, the terms "about" or "approximately" when preceding a numerical value may indicate the value plus or minus a range of 1, 2, 3, 4 or 5 pounds per square inch (psi). In further aspects, the terms "about" or "approximately" when preceding a numerical value may indicate the value plus or minus a range of 1, 2, 3, 4 or 5% relative humidity (RH). In still further aspects, the terms "about" or "approximately" when preceding a numerical value indicates the value plus or minus a range of 5, 10, 15, 20, or 30 minutes.

Furthermore the transitional phrase "comprising" that is synonymous with "including," "containing," and "characterized by" as used herein is inclusive or open-ended and does not exclude additional, unrecited elements, steps or ingredients. Alternatively the transitional phrase "consisting of" as used herein is closed and excludes any element, step or ingredient not specified. The transitional phrase "consisting essentially of" limits the scope of a claim to the specified materials or steps and those that do not materially affect the basic and novel characteristics of the claims.

Referring to FIG. 1, a system 10 for treating hardened concrete is illustrated. The system 10 may comprise a first conveyance device 12, a second conveyance device 14, and an apparatus 16 for treating the RCA. The first conveyance device 12 may be configured to transport untreated RCA to the system 10. The second conveyance device 14 may be configured to transport treated RCA away from the system 10. The apparatus 16 is configured to treat the RCA with carbon dioxide gas in a pressurized environment to accelerate the carbonation of the RCA. The carbonation treatment may improve the mechanical and chemical properties of the untreated RCA, enabling subsequent reuse in high-value construction applications such as, but not limited to, new concrete production, asphalt pavement, structural fill, road base materials, and pipe bedding.

Shown in FIG. 1, the first conveyance device 12 and the second conveyance device 14 may include conveyance equipment typically used in the commercial construction industry. In some aspects, the first conveyance device 12 and the second conveyance device 14 may include belt conveyors. In other aspects, the first conveyance device 12 and the second conveyance device 14 may include auger conveyors. In further aspects, the first conveyance device 12 and the second conveyance device 14 may include machine loaders, such as wheel loaders and similar equipment used in the construction industry. In still further aspects, the first conveyance device 12 and the second conveyance device 14 may include combinations of belt conveyors, auger conveyors, and machine loaders.

Further shown in FIG. 1, the first conveyance device 12 may be positioned proximate to a first opening of the apparatus 16 for loading untreated RCA into the apparatus 16. The second conveyance device 14 may be positioned proximate to a second opening of the apparatus 16 for receiving treated RCA discharged from the apparatus 16. The second conveyance device 14 may transport treated RCA to a destination away from the system 10. In some aspects, the destination may include an awaiting semi-trailer vehicle. In other aspects, the destination may include a stockpile. In further aspects, the destination may include a concrete or asphalt batch plant. In still further aspects, the destination may include a construction site. The system 10 is designed to facilitate the loading of untreated RCA into the apparatus 16, the treatment of the RCA within the apparatus 16, and the unloading of treated RCA onto the second conveyance device 14 for transportation to the destination. The integration of the first conveyance device 12 and the second conveyance device 14 with the apparatus 16 may facilitate continuous loading and unloading operations, thereby improving operational efficiency and throughput for commercial applications.

In some aspects, the first conveyance device 12 may include a weighing scale (not shown) configured to measure the weight of untreated RCA being transported to the system 10. In other aspects, the second conveyance device 14 may include a weighing scale configured to measure the weight of treated RCA being transported away from the system 10. The weighing scales on the first conveyance device 12 and the second conveyance device 14 may enable the controller 34 to determine a weight increase in the treated RCA as compared to the untreated RCA, which may provide an indication of calcium carbonate mineralization during the carbonation treatment process. The weight increase may correspond to the mass of carbon dioxide sequestered within the RCA during treatment.

Still further shown in FIG. 1, a carbon dioxide source 18 may be positioned proximate to the apparatus 16 and may be configured to be fluidly connected to the treatment tank 22 for supplying carbon dioxide in a gaseous state. In some aspects, the carbon dioxide source 18 may comprise an external, large refillable static container for supplying carbon dioxide. In other aspects, the carbon dioxide source 18 may comprise a plurality of external, small portable containers assembled on at least one storage rack. The carbon dioxide to be supplied to the treatment tank 22 from the carbon dioxide source 18 may be in a gaseous state, and not in a liquid state.

Also shown in FIG. 1, an optional vaporizer 20 may be positioned between the carbon dioxide source 18 and the apparatus 16. The vaporizer 20 may be configured to convert liquid carbon dioxide from the carbon dioxide source 18 into gaseous carbon dioxide for introduction into the apparatus 16. In some aspects, the vaporizer 20 may comprise an atmospheric vaporizer that utilizes ambient heat to convert the liquid carbon dioxide into gaseous carbon dioxide. In other aspects, the vaporizer 20 may comprise a heated vaporizer that utilizes an external heat source to accelerate the conversion of liquid carbon dioxide into gaseous carbon dioxide, thereby reducing the time required to fill and pressurize the chamber 24. In further aspects, the apparatus 16 may include multiple vaporizers 20 to further increase the vaporizing capacity and reduce filling time.

The system 10 may include a post-treatment screen configured to separate the treated RCA into desired size fractions following the carbonation treatment process. The post-treatment screen may be positioned downstream of the second opening 28 of the treatment tank 22 and upstream of the second conveyance device 14. In some aspects, the post-treatment screen may comprise a vibrating screen configured to separate treated RCA based on particle size. In other aspects, the post-treatment screen may comprise a series of screens having different mesh sizes configured to produce multiple size fractions of treated RCA. The post-treatment screen may be configured to produce a final gradation of treated RCA suitable for use in concrete or asphalt mix applications. In some aspects, the post-treatment screen may be configured to produce treated RCA meeting specifications for concrete mix applications. In other aspects, the post-treatment screen may be configured to produce treated RCA meeting specifications for Asphalt Cement Concrete (ACC) applications. The post-treatment screen may remove undersized particles, oversized particles, or both from the treated RCA to produce a gradation conforming to applicable specifications for the intended application. In further aspects, the post-treatment screen may be configured to produce multiple gradation products from a single treatment batch, enabling the system 10 to supply treated RCA for different end-use applications.

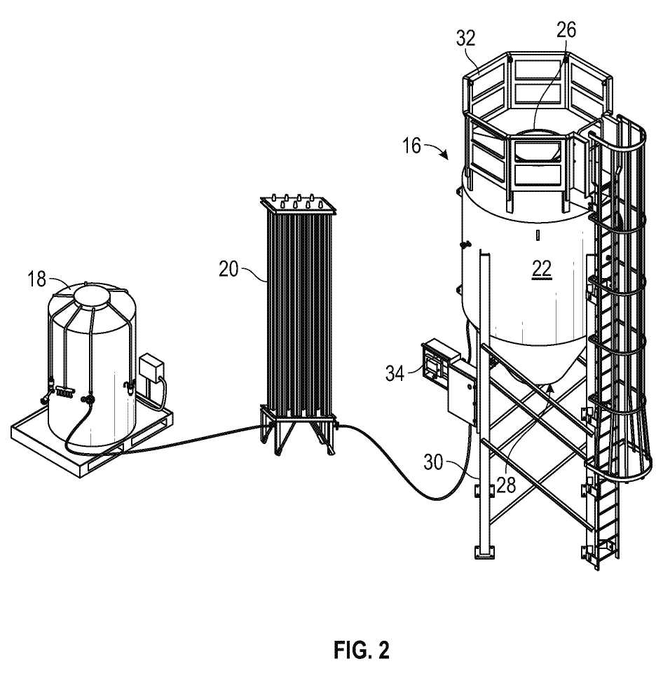

Referring to FIG. 2, an apparatus 16 for treating hardened concrete is illustrated in a vertical configuration orientation. The apparatus 16 may comprise a treatment tank 18 maintained by a support assembly 30. The apparatus 16 may be manufactured of steel, metal alloys, plastics, or combinations thereof. The apparatus 16 may be the same apparatus utilized by the system 10 described above with reference to FIG. 1.

Shown in FIG. 2, the treatment tank 18 may include a chamber 22 configured to hold recycled concrete aggregates during the carbonation treatment process. The chamber 22 may have a first opening 24 positioned at an upper portion of the treatment tank 18 and a second opening 26 positioned at a lower portion of the treatment tank 18. The first opening 24 may be designed to receive untreated RCA into the chamber 22 from the first conveyance device 12. The second opening 26 may be designed to expel treated RCA out of the chamber 22 and away from the treatment tank 18 to the second conveyance device 14. While the chamber 22 is depicted in the figures as cylindrical, other tubular shapes may also be utilized, including rectangular, triangular, square, hexagonal, octagonal, and other configurations.

The chamber 22 may be configured to operate within a range of pressure conditions during the carbonation treatment process. As a non-limiting example, the range of carbon dioxide gas pressure conditions during the carbonation process may range between approximately 60-150 pounds per square inch (psi). In some aspects, the chamber 24 may be pressurized with carbon dioxide gas to approximately 60-80psi. In other aspects, the chamber 24 may be pressurized with carbon dioxide gas to approximately 80-120psi. In further aspects, the chamber 24 may be pressurized with carbon dioxide gas to approximately 120-150psi. The pressure within the chamber 24 may be selected based on the desired carbonation rate, the input feedstock properties of the RCA, and the treatment time requirements for the application.

The increased pressure environment within the chamber 24 may drive carbon dioxide gas into the pore structures of the RCA at an accelerated rate. The elevated pressure creates a pressure differential between the carbon dioxide atmosphere within the chamber 24 and the internal pore spaces of the RCA, which may force the carbon dioxide gas to penetrate more deeply and rapidly into the existing pore structures, microcracks, and capillary networks present in the hardened aggregate material. This pressure-driven penetration mechanism is fundamentally different from ambient carbonation processes, where carbon dioxide diffusion into the aggregate pores occurs passively and is limited by concentration gradients alone. The pressurized treatment environment of the present disclosure may increase the concentration of carbon dioxide molecules available at the reaction sites within the residual cement paste, thereby accelerating the rate of the carbonation reaction. Additionally, the elevated pressure may compress the carbon dioxide gas to a higher density while maintaining the gaseous state, increasing the mass of carbon dioxide available per unit volume within the chamber 24 and enhancing the overall efficiency of the carbonation treatment process.

Further shown in FIG. 2, the support assembly 30 may be configured to maintain the treatment tank 22 at a designated position relative to the first conveyance device 12 and the second conveyance device 14. The support assembly 30 may be vertically oriented to suspend the treatment tank 22 above the second conveyance device 14 at a designated position. In some aspects, the support assembly 30 may vertically suspend the treatment tank 22 at a height ranging between approximately 20-25 feet. In other aspects, the support assembly 30 may vertically suspend the treatment tank 22 at a height greater than 25 feet. The elevated position of the treatment tank 22 may facilitate gravity-assisted loading of untreated RCA through the first opening 26 and gravity-assisted unloading of treated RCA through the second opening 28.

Still further shown in FIG. 2, safety measures 32 may be incorporated into the apparatus 16 to safeguard an operator during operation. In some aspects, the safety measures 32 may include a guardrail mounted around a perimeter of an upper portion of the treatment tank 22 to provide fall protection for operators accessing the upper portion of the treatment tank 22 during loading operations, inspection, or maintenance activities. In other aspects, the safety measures 32 may include an enclosed ladder mounted on an exterior wall of the chamber 24 of the treatment tank 22 and the support assembly 30 to provide safe vertical access between ground level and the upper portion of the treatment tank 22. In further aspects, the safety measures 32 may include tie-off points as confined space provisions for compliance, enabling operators to secure personal fall arrest systems when working at elevated positions on the apparatus 16 or when accessing the interior of the chamber 24. In still further aspects, the safety measures 32 may include lockout/tagout confined space provisions for compliance, enabling operators to isolate energy sources and prevent inadvertent operation of the apparatus 16 during maintenance, inspection, or cleaning activities within the chamber 24. In other aspects, the safety measures 32 may include air quality monitoring equipment configured to measure oxygen levels and carbon dioxide concentrations inside and around the apparatus 16 to ensure safe atmospheric conditions for workers and to prevent injury due to oxygen displacement. In yet further aspects, the safety measures 32 may include combinations of guardrails, enclosed ladders, tie-off points, lockout/tagout provisions, and air quality monitors.

In some aspects, the apparatus 16 may include at least one manway. The at least one manway may be positioned on an exterior wall of the treatment tank 22 and may be configured to provide access to an interior of the treatment tank 22 for inspection, maintenance, or cleaning activities. The at least one manway may comprise a sealable access door or hatch sized to permit entry of an operator into the treatment tank 22. In other aspects, the at least one manway may be hermetically sealable to maintain pressurization of the chamber 24 during the carbonation treatment process. The at least one manway may facilitate efficient access to the interior of the treatment tank 22 without requiring entry through the first opening 24 or the second opening 26.

In other aspects, the apparatus 16 may include an electric hookup panel. The electric hookup panel may be configured to provide electrical power to the apparatus 16 for operation of the controller 34, the safety measures 30, and other electrically powered components of the apparatus 16. In further aspects, the electric hookup panel may be configured for connection to a generator for portable or mobile applications where grid power may not be available. In additional aspects, the electric hookup panel may be configured for hard wire connection to a fixed electrical supply for stationary installations. In further aspects, the electric hookup panel may be configured for both generator and hard wire options, enabling the apparatus 16 to operate in various deployment configurations. The dual-configuration electric hookup panel may facilitate use of the apparatus 16 at remote work sites, demolition sites, or crushing facilities where temporary generator power may be utilized, as well as at permanent installations where fixed electrical infrastructure may be available.

Also shown in FIG. 2, a controller 34 may be provided and configured to operate the apparatus 16 for treating the RCA. The controller 34 may include a computer processor, databases, and applications. In some aspects, the controller 34 may comprise a programmable logic controller (PLC), a general purpose programmable computer, or a dedicated microcontroller, and may include a machine-readable storage medium storing executable instructions for operating the apparatus 16.

The controller 34 may allow an operator to manually operate the apparatus 16, may allow automatic operation of the apparatus 16, or combinations thereof. In some aspects, the controller 34 may operate in a fully automatic mode in which the controller 34 automatically monitors treatment conditions, adjusts treatment parameters, and initiates loading and unloading operations without operator intervention. In other aspects, the controller 34 may operate in a manual mode in which the controller 34 monitors treatment conditions and displays relevant information to an operator via a display or user interface, including pressure, temperature, treatment time, and relative humidity inside the chamber 24, and the operator manually adjusts treatment parameters and initiates loading and unloading operations based on the information displayed by the controller 34. In further aspects, the controller 34 may operate in a semi-automatic mode in which the controller 34 automatically monitors and adjusts certain treatment parameters while providing information to the operator for manual adjustment of other treatment parameters. The selection of automatic, manual, or semi-automatic operation may be determined by the operator based on the specific application requirements and operational preferences. The display or user interface may be positioned locally adjacent to the apparatus 16, or may be accessible remotely via a networked device such as a phone, computer, tablet, smart device, or other remote computing device, enabling an operator to monitor and control the apparatus 16 from a location remote from the chamber 24.

The combination of elevated pressure, active gas circulation, and controlled treatment conditions within the sealed chamber 24 collectively contributes to the rapid carbonation capability of the apparatus 16, enabling treatment cycle times ranging between approximately 4-12 hours that are substantially shorter than those achievable through ambient or low-pressure carbonation approaches. In some aspects, the treatment time required to achieve effective carbonation of the RCA may be inversely related to the pressure within the chamber 24. For example, at higher pressures, such as approximately 120-150psi, treatment times may be reduced to approximately 4 to 6 hours. At moderate pressures, such as approximately 80-120psi, treatment times may range between approximately 6 to 8 hours. At lower pressures, such as approximately 60-80psi, treatment times may range between approximately 8 to 12 hours. The controller 34 may be configured to select pressure and treatment time combinations based on the input feedstock properties of the RCA and the desired throughput rate. In some aspects, the controller 34 may increase pressure within the chamber 24 to reduce treatment time when higher throughput is desired, or may decrease pressure and extend treatment time when energy conservation or carbon dioxide consumption reduction is prioritized.

The controller 34 may be configured to maintain relative humidity within the chamber 24 at a set range during the carbonation treatment process to optimize carbonation reaction conditions. In some aspects, the relative humidity within the chamber 24 may be maintained between approximately 50% and 65% relative humidity. In other aspects, the relative humidity within the chamber 24 may be maintained between approximately 65% and 80% relative humidity. The relative humidity range may be selected based on the moisture content of the untreated RCA, the desired carbonation rate, and the need to avoid excessive moisture that could impede carbon dioxide gas penetration into the pore structures of the RCA. Insufficient relative humidity may limit the carbonation reaction rate because water is required for the dissolution of carbon dioxide and the subsequent reaction with calcium hydroxide. Excessive relative humidity may fill the pore spaces of the RCA with liquid water, blocking carbon dioxide gas from reaching the reaction sites within the residual cement paste.

The controller 34 may also be configured to maintain temperature within the chamber 24 at a set range during the carbonation treatment process. In some aspects, the temperature within the chamber 24 may be maintained between approximately 32° F and 150° F. In other aspects, the temperature within the chamber 24 may be maintained between approximately 70° F and 90° F. In further aspects, the temperature within the chamber 24 may be maintained at approximately 80° F. The temperature range may be selected based on the desired carbonation reaction rate and the need to avoid temperatures that could adversely affect the carbonation process or the structural integrity of the RCA. Elevated temperatures may increase the rate of the carbonation reaction, while excessively high temperatures may cause premature drying of the RCA or other undesirable effects. The exothermic nature of the carbonation reaction may cause temperature to increase within the chamber 24 during treatment, and the controller 34 may monitor and adjust temperature conditions to maintain the temperature within the desired range throughout the treatment cycle.

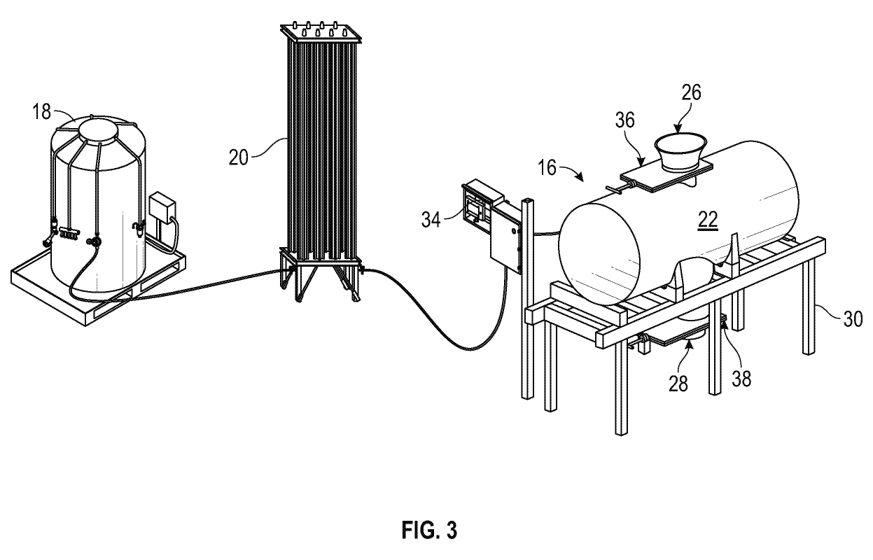

Referring to FIG. 3, the apparatus 16 for treating hardened concrete is illustrated in a horizontal orientation configuration. The apparatus 16 of FIG. 3 may comprise a similar treatment tank 22, support assembly 30, safety measures 32, first opening 26, second opening 28, and controller 34 as the apparatus 16 of FIG. 2, but configured in a horizontal orientation as opposed to a vertical orientation. The horizontal orientation configuration may be advantageous in certain applications where vertical space is limited or where the job site layout favors a lower-profile apparatus. For example, the horizontal orientation may be preferred at job sites with overhead obstructions, height restrictions, or where the apparatus 16 must be positioned beneath existing structures or equipment. In some aspects, the first opening 26 may be positioned at an upper portion of the treatment tank 22 above the second opening 28 to enable convenient gravity flow of the RCA through the treatment tank 22 from the first opening 26 to the second opening 28 during loading and unloading operations. In other aspects, the first opening 26 may be positioned at a first end portion of the treatment tank 22 and the second opening 28 may be positioned at a second, opposite end portion of the treatment tank 22, rather than at upper and lower portions. In such configurations, the apparatus 16 may utilize alternative mechanisms such as augers, conveyors, tilting mechanisms, or pneumatic systems to facilitate loading of untreated RCA into the chamber 24 through the first opening 26 and unloading of treated RCA from the chamber 24 through the second opening 28. In further aspects, the apparatus 16 may be configured to transition between the vertical orientation of FIG. 2 and the horizontal orientation of FIG. 3 depending on the specific requirements of the job site, available space, and operational preferences. The ability to transition between vertical and horizontal orientations for the same apparatus 16 may provide flexibility for deployment across a variety of job site configurations and space constraints.

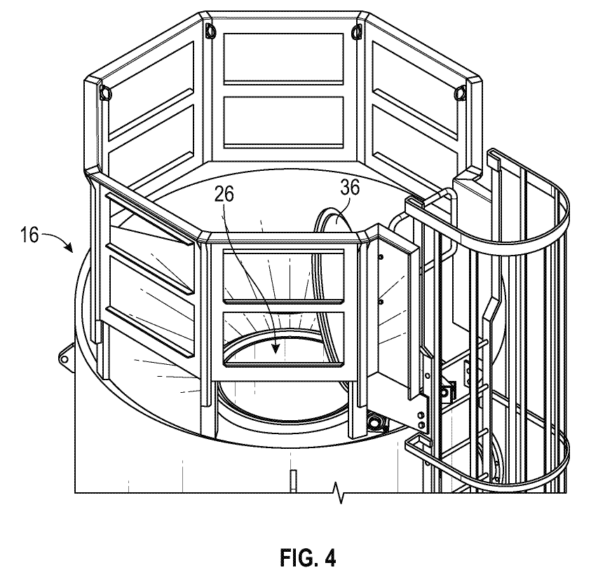

Referring to FIG. 4, a first opening 26 is illustrated of the apparatus 16 in the vertical orientation configuration. The first opening 26 may be positioned at an upper portion of the treatment tank 22 and may be configured to receive untreated RCA into the chamber 24 from the first conveyance device 12. The treatment tank 22 may comprise an upper, first portion having a first tapered frustoconical sidewall with the first opening 26 centered therein. The first tapered frustoconical sidewall may provide a funnel-like receiving area designed to direct untreated RCA from the first conveyance device 12 into an interior of a chamber 24 of the treatment tank 22. In some aspects, the first opening 26 and the first tapered frustoconical sidewall may be sized and configured to receive aggregate material directly from the first conveyance device 12 without requiring intermediate handling steps. The sizing of the first opening 26 may be selected to accommodate the discharge width or diameter of the first conveyance device 12, such as the belt width of a belt conveyor or the discharge chute of an auger conveyor.

Shown in FIG. 4, the first opening 26 may comprise a first door 36. The first door 36 may comprise a hermetically sealable door configured to seal the first opening 26 during the carbonation treatment process, enabling the chamber 24 to maintain pressurization. The first door 36 may be operated by hydraulics, pneumatics, or equivalents thereof. In some aspects, the first door 36 may comprise an operable hatch having a hinged or pivoting closure mechanism that swings open to receive untreated RCA from the first conveyance device 12 and swings closed to seal the first opening 26 during pressurization.

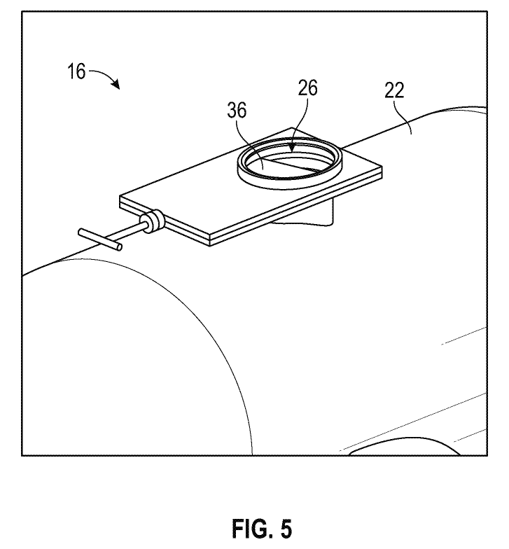

Referring to FIG. 5, the first door 36 may comprise a slide gate having a sliding closure mechanism that translates laterally or linearly to open and close the first opening 26. FIG. 5 illustrates the slide gate door configuration at the first opening 26 of the apparatus 16 in the horizontal orientation configuration of FIG. 3. The slide gate may be operated by hydraulics, pneumatics, or equivalents thereof, similar to the hinged door configuration of FIG. 4. The slide gate door configuration may be hermetically sealable, similar to the hinged door configuration, to enable the chamber 24 to maintain pressurization during the carbonation treatment process. The slide gate configuration may facilitate rapid loading operations in commercial applications because the slide gate may be opened and closed more rapidly than a hinged or pivoting hatch, thereby reducing the time required for loading cycles. In some aspects, the slide gate may be utilized in place of the hinged door at the first opening on the vertically oriented apparatus of FIG. 2, and the hinged door may be utilized in place of the slide gate on the horizontally oriented apparatus of FIG. 3. The selection of the hinged door or the slide gate for the first opening 26 may be determined based on the orientation of the apparatus 16, the specific requirements of the job site, and the desired loading cycle time.

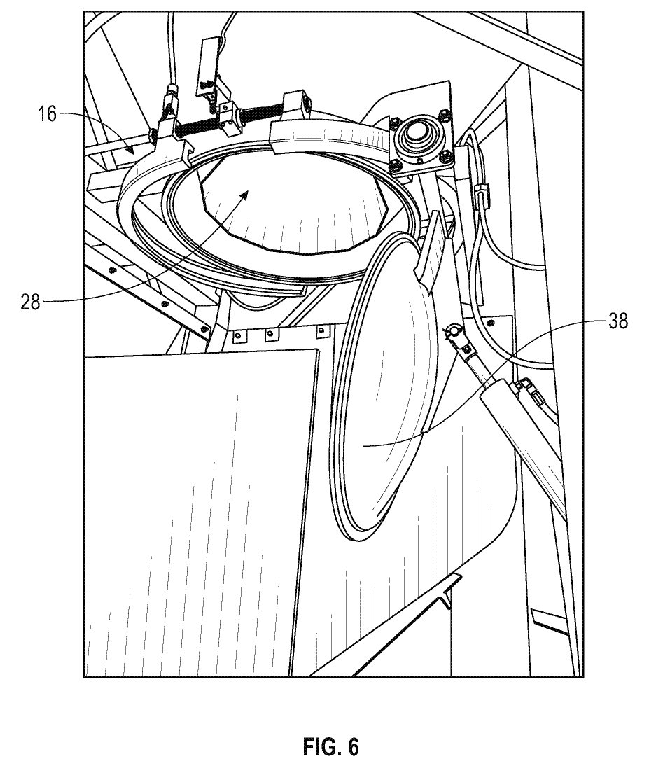

Referring to FIG. 6, a second opening 28 is illustrated of the apparatus 16 in the vertical orientation configuration. The treatment tank 22 may comprise a lower, second portion having a second tapered sidewall with the second opening 28 centered therein. In some aspects, the second tapered sidewall may comprise a frustoconical shaped sidewall. In other aspects, the second tapered sidewall may comprise a conical shaped sidewall. The second tapered sidewall and the second opening 28 may be designed to discharge treated RCA out of the chamber 24 and away from the treatment tank 22. The frustoconical or conical geometry of the second tapered sidewall may facilitate the unloading of treated RCA from the chamber 24 to a second conveyance device 14 by directing the aggregate material toward the second opening 28 under the influence of gravity.

In some aspects, the second opening 28 having a second tapered sidewall may be sized and configured to discharge treated aggregate material directly onto the second conveyance device 14 without requiring intermediate handling steps laterally or linearly to open and close the first opening 24, which may facilitate rapid loading operations in commercial application such as baskets, shovels, or manual transfer. The direct alignment of the first opening 26 with the first conveyance device 12 and the second opening 28 with the second conveyance device 14 may eliminate the need for labor-intensive manual handling of bulk aggregate materials, thereby enabling the system 10 to achieve commercial-scale throughput rates.

Shown in FIG. 6, the second opening 28 may comprise a second door 38. The second door 38 may comprise a hermetically sealable door configured to seal the second opening 28 during the carbonation treatment process. The second door 38 may be operated by hydraulics or equivalents thereof. In some aspects, the second door 38 may comprise an operable hatch configured to be pressure sealed. In other aspects, the second door 38 may comprise a slide gate configured for mass-unloading RCA from the treatment tank 22. The operable hatch configuration may provide a hinged or pivoting closure mechanism that swings open to discharge treated RCA and swings closed to seal the second opening 28 during pressurization. The slide gate configuration may provide a sliding closure mechanism that translates laterally or linearly to open and close the second opening 28, which may facilitate rapid unloading operations in commercial applications.

The hermetically sealable configuration of the second door 38 may enable the chamber 24 to maintain pressurization during the carbonation treatment process while allowing controlled discharge of treated material upon completion of the treatment cycle. The second opening 28 and the second door 38 may be sized and configured to accommodate mass-unloading of bulk aggregate materials to the second conveyance device 14. In a vertical orientation, the positioning of the second opening 28 at the lower portion of the treatment tank 22 may allow gravity to assist in directing treated RCA out of the chamber 24 during unloading operations. In a horizontal orientation, the apparatus 16 may utilize alternative mechanisms such as augers, conveyors, tilting mechanisms, or pneumatic systems to facilitate unloading of treated RCA from the chamber 24 through the second opening 28. The second door 38 may be positioned adjacent to the second conveyance device 14 to facilitate efficient transfer of treated RCA from the treatment tank 22 to the second conveyance device 14 for transportation away from the system 10.

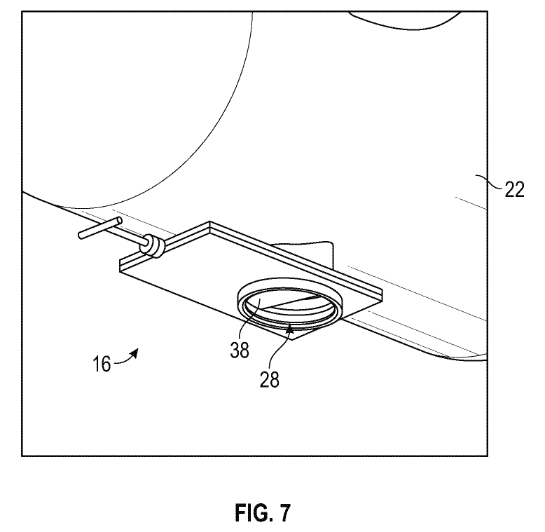

Referring to FIG. 7, the second door 38 may comprise a slide gate having a sliding closure mechanism that translates laterally or linearly to open and close the second opening 28. FIG. 7 illustrates the slide gate door configuration at the second opening 28 of the apparatus 16 in the horizontal orientation configuration of FIG. 3. The slide gate at the second opening 28 may have the same functionality as the slide gate at the first opening 26 described above with reference to FIG. 5, including a hermetically sealable sliding closure mechanism operated by hydraulics, pneumatics, or equivalents thereof. Similar to the first door 36, the slide gate at the second opening 28 may be interchangeable with the hinged door configuration of FIG. 6, and the selection may be determined based on the orientation of the apparatus 16, the specific requirements of the job site, and the desired unloading cycle time.

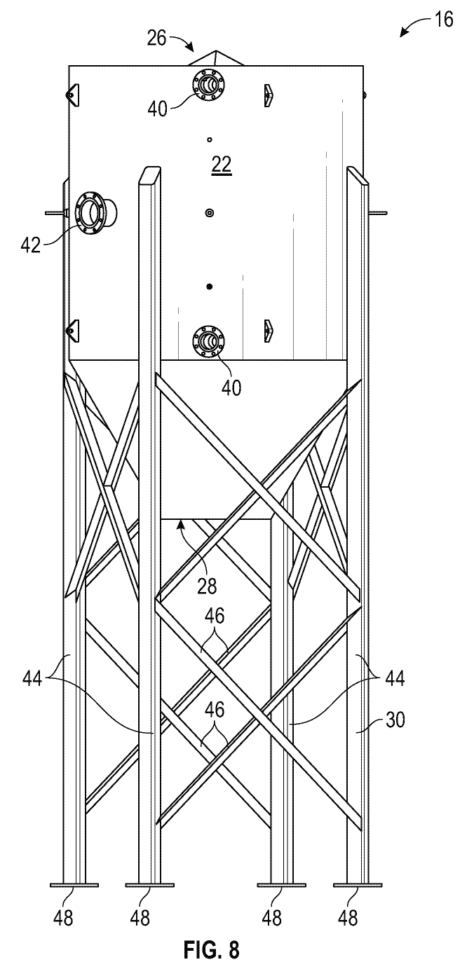

Referring to FIG. 8, a side view of the apparatus 16 is illustrated showing the treatment tank 22, the support assembly 30, the at least one inlet port 40, and the at least one outlet port 422. The at least one inlet port 40 may be positioned on an exterior wall of the chamber 24 and may be configured to fluidly connect the treatment tank 22 to the carbon dioxide source 18 for supplying carbon dioxide gas in a gaseous state to pressurize the chamber 24. In some aspects, the at least one inlet port 40 may incorporate a blower or compressor (not shown) configured to circulate gas movement inside the treatment tank 22 to increase surface area contact of the RCA with the carbon dioxide gas during treatment. In other aspects, the at least one inlet port 40 may comprise a valve purge opening configured to enable nitrogen gas (N₂) to be injected into the treatment tank 22 to purge ambient air from the chamber 24 before pressurization with carbon dioxide gas. The nitrogen purge may displace oxygen and other atmospheric gases from the chamber 24 prior to introduction of carbon dioxide gas, thereby improving the purity of the carbon dioxide atmosphere within the chamber 24 and enhancing the efficiency of the carbonation treatment process.

Shown in FIG. 8, the at least one outlet port 42 may be positioned on the exterior wall of the chamber 24 and may be configured to remove excess carbon dioxide gas from the treatment tank 22 after treatment of the RCA. In some aspects, a vacuum system may be connected to the at least one outlet port 422 to facilitate the removal and collection of excess carbon dioxide gas from the treatment tank 22. In other aspects, a blower, compressor, or purge apparatus (not shown) may be utilized in connection with the at least one outlet port 42 to facilitate the removal and collection of excess carbon dioxide gas. The blower, compressor, purge apparatus, or vacuum system may be positioned externally from the chamber 24 of the apparatus 16, such as adjacent to the exterior wall of the treatment tank 22 or on a separate support structure proximate thereto. In other aspects, an internally positioned blower, compressor purge apparatus, or vacuum system may be mounted within the chamber 24 to directly circulate carbon dioxide gas among the RCA during the carbonation treatment process. In still further aspects, the apparatus 16 may include both an internally positioned and an externally positioned blower, compressor purge apparatus, or vacuum system. The selection of an external and/or internal positioning of the blower, compressor, purge apparatus, or vacuum system may be determined based on the size of the chamber 24, the desired vapor space, and the operational requirements of the apparatus 16. The recovered carbon dioxide gas may be stored in a separate pressurized holding tank for subsequent reuse in additional treatment cycles.

The apparatus 16 may include increased airflow capacity to facilitate circulation of carbon dioxide gas throughout the chamber 24 during the carbonation treatment process. In some aspects, the blower, compressor, vacuum system, or purge apparatus positioned at the inlet and/or outlet port(s) 40, 42 may have increased horsepower to provide increased cubic feet per minute (CFM) of circulated airflow through the chamber 24. The increased airflow capacity may improve surface area contact between the carbon dioxide gas and the RCA during treatment. The controller 34 may monitor and adjust the circulated airflow through the chamber 24 based on the treatment conditions and the input feedstock properties of the RCA. The blower or compressor may be used to establish a vacuum or partial vacuum condition within the chamber 24 after the RCA are loaded into the chamber 24 and before carbon dioxide gas is introduced. The vacuum or partial vacuum condition may evacuate ambient air, including oxygen, nitrogen, and moisture, from the chamber 24 prior to the introduction of carbon dioxide gas. By removing ambient air from the chamber 24 before pressurization, the vacuum or partial vacuum condition may improve the purity level of the carbon dioxide gas atmosphere within the chamber 24 during the carbonation treatment process. A higher purity carbon dioxide atmosphere within the chamber 24 may increase the concentration of carbon dioxide molecules available at the reaction sites within the residual cement paste of the RCA, thereby accelerating the rate of the carbonation reaction. The removal of oxygen from the chamber 24 may also reduce the potential for undesirable oxidation reactions that could compete with the carbonation reaction. Additionally, the removal of ambient moisture from the chamber 24 prior to pressurization may enable the controller 34 to more precisely control relative humidity within the chamber 24 during the carbonation treatment process, as the initial moisture content of the atmosphere within the chamber 24 may be reduced to a known baseline. The improved carbon dioxide purity and reduced atmospheric contaminants resulting from the pre-treatment vacuum condition may contribute to shorter treatment cycle times and more efficient use of carbon dioxide gas, as a greater proportion of the carbon dioxide gas introduced into the chamber 24 may be available for the carbonation reaction rather than being diluted by residual ambient air.

Also shown in FIG. 8, the support assembly 30 may comprise a plurality of legs 44 and a plurality of cross-sections 46. The plurality of cross-sections 46 may be rigidly connected to the plurality of legs 44 to provide reinforcement to the support assembly 30. Each leg of the plurality of legs 44 may comprise a base plate 48 positioned on a lower portion thereof to provide stability to the support assembly 30. In some aspects, the plurality of legs 44 may each have a length ranging between approximately 20-25 feet. In other aspects, the plurality of legs 44 may each have a length greater than 25 feet. In further aspects, the plurality of legs 44 may each have a length less than 25 feet. In some aspects, the plurality of cross-sections 46 may each have a length ranging between approximately 10-15 feet. In other aspects, the plurality of cross-sections 46 may each have a length greater than 15 feet. In further aspects, the plurality of cross-sections 46 may each have a length less than 15 feet.

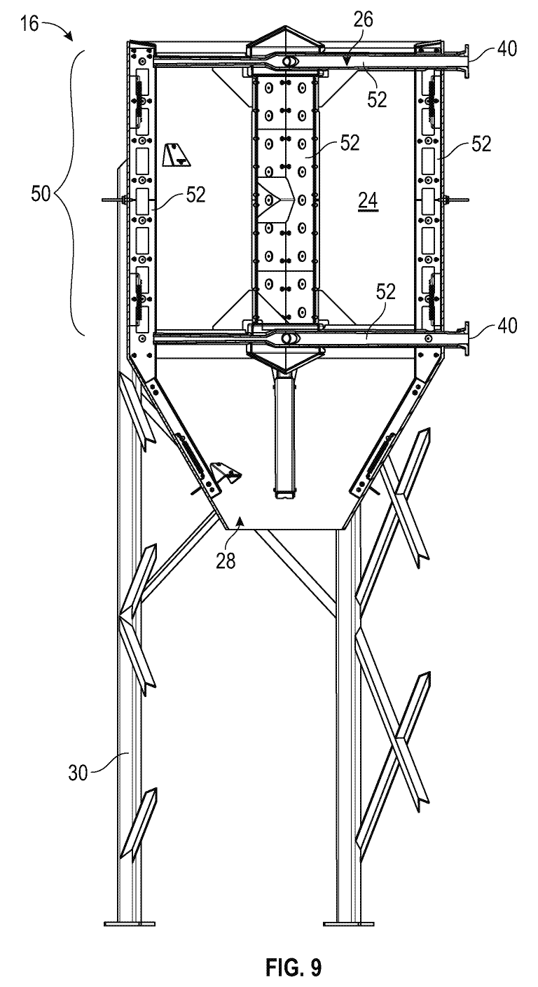

Referring to FIG. 9, a front cross-sectional view of the apparatus 16 is illustrated, revealing the internal components 50 within the chamber 24 of the treatment tank 22. The internal components 50 may comprise a plurality of ducts 52 configured to circulate carbon dioxide gas throughout the treatment tank 22 to expose the RCA therein for carbonation treatment. The structured arrangement of the plurality of ducts 52 is designed to actively distribute pressurized carbon dioxide gas from the inlet port 40 through the central duct and outward through the cross ducts to the outer ducts, creating multiple gas delivery points throughout the chamber 24. The outer ducts extending into the lower second portion of the treatment tank 22 toward the second opening 28 ensure that carbon dioxide gas reaches the RCA positioned in the lower regions of the chamber 24, where gas penetration may otherwise be limited by the weight and density of the overlying aggregate mass.

The chamber 24 may have dimensional configurations suitable for accommodating bulk quantities of RCA for mass-scale commercial applications. In some aspects, the chamber 24 may have a height or length ranging between approximately 10-50 feet. In other aspects, the chamber 24 may have a height or length greater than approximately 30 feet. The height or length dimension may correspond to the vertical extent of the chamber 24 in a vertical orientation or the horizontal extent of the chamber 24 in a horizontal orientation. In further aspects, the chamber 24 may have a width or diameter ranging between approximately 4-15 feet. In still further aspects, the chamber 24 may have a width or diameter greater than approximately 15 feet. The dimensional configuration of the chamber 24 may be selected based on the orientation of the treatment tank 22, the configuration of the support assembly 30, and the positioning of the first conveyance device 12 and the second conveyance device 14 relative to the apparatus 16. In some aspects, the chamber may have a volume ranging between approximately 400 cubic feet and 4,600 cubic feet. In other aspects, the treatment tank may be configured to treat between approximately 10 tons and 230 tons of RCA per treatment cycle.

In some aspects, a vapor space within the chamber 24 may be maintained during the carbonation treatment process. The vapor space may comprise an unoccupied volume within the chamber 24 above the RCA loaded therein. The vapor space may range between approximately 10% and 50% of the total volume of the chamber 24. Maintaining the vapor space within this range may provide sufficient air movement throughout the chamber 24 to ensure adequate carbonation of the RCA. Insufficient vapor space may restrict the circulation of pressurized carbon dioxide gas within the chamber 24, potentially resulting in uneven gas distribution, reduced contact between the carbon dioxide gas and the surfaces of the RCA, and incomplete or non-uniform carbonation treatment. In some aspects, the vapor space may be at least 10% of the total volume of the chamber 24 to provide a minimum volume for adequate gas circulation. In other aspects, the vapor space may be at least 20% of the total volume of the chamber 24 to provide enhanced gas circulation and improved carbonation uniformity. In further aspects, the vapor space may be up to approximately 50% of the total volume of the chamber 24 to maximize gas circulation capacity. The vapor space may facilitate circulation of carbon dioxide gas throughout the treatment tank 22 via the internal components 50 and the plurality of ducts 52, and may enable the pressurized carbon dioxide gas to contact exposed surfaces of the RCA during the carbonation treatment process. The maintenance of the vapor space may be controlled by limiting the quantity of RCA loaded into the treatment tank 22 through the first opening 26 during loading operations. The controller 34 may be configured to monitor the volume of RCA loaded into the treatment tank 22 and to ensure that the vapor space remains within the desired range for optimal gas circulation and carbonation treatment.

In other aspects, the internal components 50 may comprise a plurality of sensors for measuring temperature, pressure, relative humidity, and air circulation inside the treatment tank 22. The plurality of sensors may be configured to monitor conditions within the chamber 24 during the carbonation treatment process. In some aspects, the plurality of sensors may include at least one temperature sensor, such as a thermocouple, a resistance temperature detector (RTD), or a thermistor, configured to measure the temperature within the chamber 24. In other aspects, the plurality of sensors may include at least one pressure sensor, such as a pressure transducer or a pressure gauge, configured to measure the pressure of carbon dioxide gas within the chamber 24. In further aspects, the plurality of sensors may include at least one relative humidity sensor, such as a capacitive humidity sensor or a resistive humidity sensor, configured to measure the relative humidity within the chamber 24. In still further aspects, the plurality of sensors may include at least one air circulation sensor, such as an anemometer or a hot-wire sensor, configured to measure the rate of gas circulation within the chamber 24. The plurality of sensors may be mounted at one or more locations within the chamber 24 or on the exterior wall of the chamber 24 to provide representative measurements of the treatment conditions throughout the treatment tank 22.

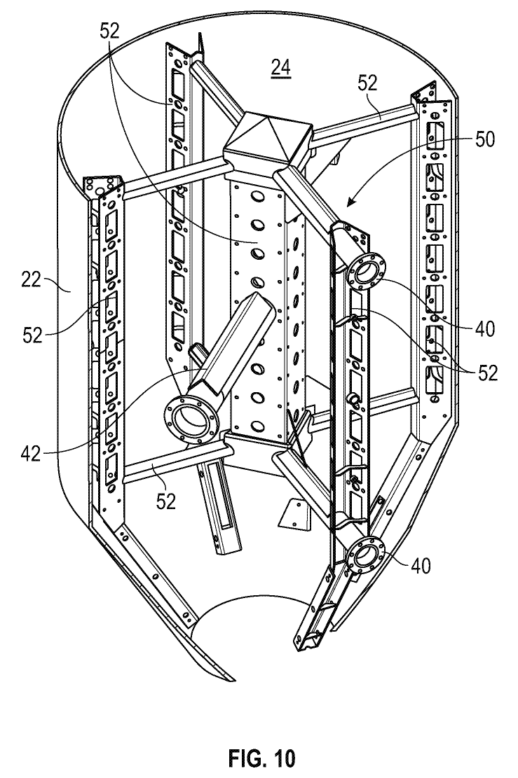

Referring to FIG. 10, a perspective cross-sectional view of the apparatus 16 is illustrated, revealing the internal components 50 within the chamber 24 of the treatment tank 22. The internal components 50 may comprise a plurality of ducts 52 configured to circulate carbon dioxide gas throughout the treatment tank 22. The plurality of ducts 52 may include a central duct mounted vertically in the chamber 24, a plurality of outer ducts mounted vertically in the chamber 24 and extending downward into the lower, second portion of the treatment tank 22 toward the second opening 28, and a plurality of cross ducts fluidly connecting the central duct to the plurality of outer ducts. The plurality of ducts 52 may further include at least one inlet duct fluidly connecting the at least one inlet port 40 to the central duct and the plurality of cross ducts, and a series of pipe adapters configured to assist with gas circulation through the treatment tank 22. The structured arrangement of the plurality of ducts 52 is designed to actively distribute carbon dioxide gas from the inlet port 40 through the central duct and outward through the cross ducts to the outer ducts, creating multiple gas delivery points throughout the chamber 24 to create a pressurized environment for the RCA. The outer ducts extending into the lower second portion of the treatment tank 22 toward the second opening 28 ensure that carbon dioxide gas reaches the RCA positioned in the lower regions of the chamber 24, where gas penetration may otherwise be limited by the weight and density of the overlying aggregate mass.

In some aspects, the carbonation treatment provided by the apparatus 16 may reduce the concentration of alkali hydroxides within the residual cement paste of the RCA. Alkali-silica reaction (ASR) is a deleterious chemical reaction that may occur in concrete when reactive silica phases in the aggregate react with alkali hydroxides from the cement paste to produce an expansive alkali-silica gel. RCA produced from structures affected by ASR may contain both reactive silica and elevated concentrations of alkali hydroxides in the adhered mortar, which may induce ASR-related expansion and damage when the RCA is used in new concrete. The rapid, pressurized carbonation treatment of the present disclosure may reduce the concentration of alkali hydroxides within the RCA by converting calcium hydroxide to calcium carbonate, thereby reducing the availability of hydroxide ions that participate in the ASR reaction. The uniform distribution of pressurized carbon dioxide gas throughout the treatment tank 22 via the plurality of ducts 52, combined with the controlled treatment conditions maintained by the controller 34, may provide more thorough and consistent reduction of alkali hydroxide concentrations throughout the entire batch of RCA as compared to prior art ambient carbonation approaches that may result in non-uniform treatment. The treated RCA may thus exhibit reduced ASR potential, enabling its use in new concrete applications where ASR susceptibility may otherwise be a concern.

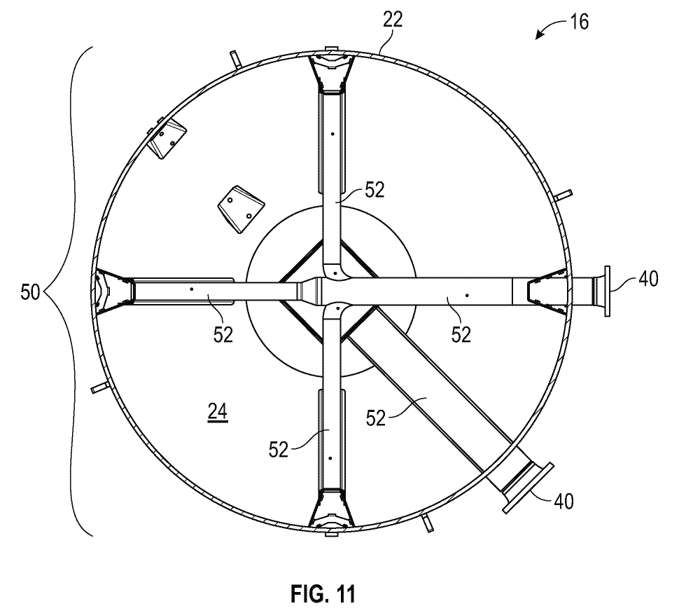

Referring to FIG. 11, a top cross-sectional view of the apparatus 16 is illustrated. The top cross-sectional view reveals the arrangement of the inlet port 40, the outlet port 42, and the internal components 50 within the chamber 24 of the treatment tank 22. The inlet port 40 may be positioned on an exterior wall of the chamber 24 and may be configured to fluidly connect the treatment tank 22 to the carbon dioxide source 18 for supplying carbon dioxide gas to the treatment tank 22. The outlet port 422 may be positioned on the exterior wall of the chamber 24 and may be configured to remove excess carbon dioxide gas from the treatment tank 22 after treatment of the RCA. The internal components 50 may include the plurality of ducts 52 configured to distribute carbon dioxide gas throughout the interior of the treatment tank 22 during the carbonation process. The plurality of ducts 52 may include a central duct mounted in the chamber 24, a plurality of outer ducts mounted in the chamber 24 and positioned radially outward from the central duct, and a plurality of cross ducts fluidly connecting the central duct to the plurality of outer ducts. The arrangement of the central duct, the plurality of outer ducts, and the plurality of cross ducts may facilitate circulation of carbon dioxide gas throughout the treatment tank 22 to expose the RCA therein for carbonation treatment.

While FIGS. 10 and 11 illustrate the plurality of ducts 52 in the vertical orientation configuration, the horizontal orientation configuration of the apparatus 16 may, in some aspects, include a similar plurality of ducts 52 adapted for horizontal gas distribution within the chamber 24. In other aspects, the horizontal orientation configuration may not include the internal plurality of ducts 52. In such instances where the plurality of ducts 52 are not included, the carbon dioxide gas may be distributed throughout the chamber 24 by alternative means, such as direct injection through the at least one inlet port 40, a blower or compressor configured to circulate the carbon dioxide gas within the chamber 24, or passive diffusion of the carbon dioxide gas through the RCA. The selection of the plurality of ducts 52 or alternative gas distribution means may be determined based on the orientation of the apparatus 16, the size of the chamber 24, and the desired gas distribution characteristics for the carbonation treatment process.

In some aspects, the apparatus 16 may further include at least one carbon dioxide flow meter configured to measure the volume of carbon dioxide gas entering and exiting the treatment tank 22 via the inlet and/or outlet port(s) 40, 42. In further aspects, the apparatus 16 may include at least one airflow gauge positioned at the inlet and/or outlet port(s) 40, 42 and configured to measure circulated airflow through the chamber 24 during the carbonation treatment process. The at least one carbon dioxide flow meter and the at least one airflow gauge may enable an operator or the controller 34 to monitor gas volume and airflow conditions within the treatment tank 22. The at least one carbon dioxide flow meter may also provide safety features to an operator by detecting carbon dioxide gas leaks from the treatment tank 22 or the associated piping and connections. In some aspects, the controller 34 may be configured to compare the volume of carbon dioxide gas entering the treatment tank 22 through the at least one inlet port 40 with the volume of carbon dioxide gas exiting the treatment tank 22 through the at least one outlet port 42, and to generate an alert or notification to the operator if a discrepancy indicates a potential leak. In other aspects, the controller 34 may be configured to automatically shut down the carbon dioxide supply from the carbon dioxide source 18 upon detection of a potential leak to prevent carbon dioxide gas from accumulating in the area surrounding the apparatus 16, which may pose a safety hazard to workers due to oxygen displacement. The carbon dioxide flow meter may further enable the controller 34 to monitor the rate of carbon dioxide consumption during the carbonation treatment process, which may provide an indication of the progress of the carbonation reaction within the chamber 24.

In other aspects, the apparatus 16 may include at least one tank sidewall vibrator (not shown). The at least one tank sidewall vibrator may be mounted on an interior and/or exterior wall of the chamber 24 and configured to facilitate unloading of treated RCA from the treatment tank 22. The at least one tank sidewall vibrator may impart vibrational energy to the sidewall of the chamber 24 to dislodge treated RCA that may adhere to interior surfaces of the treatment tank 22 during the carbonation treatment process. In other aspects, the at least one tank sidewall vibrator may be positioned adjacent to the lower, second portion of the treatment tank 22 to assist with directing treated RCA toward the second opening 28 during unloading operations.

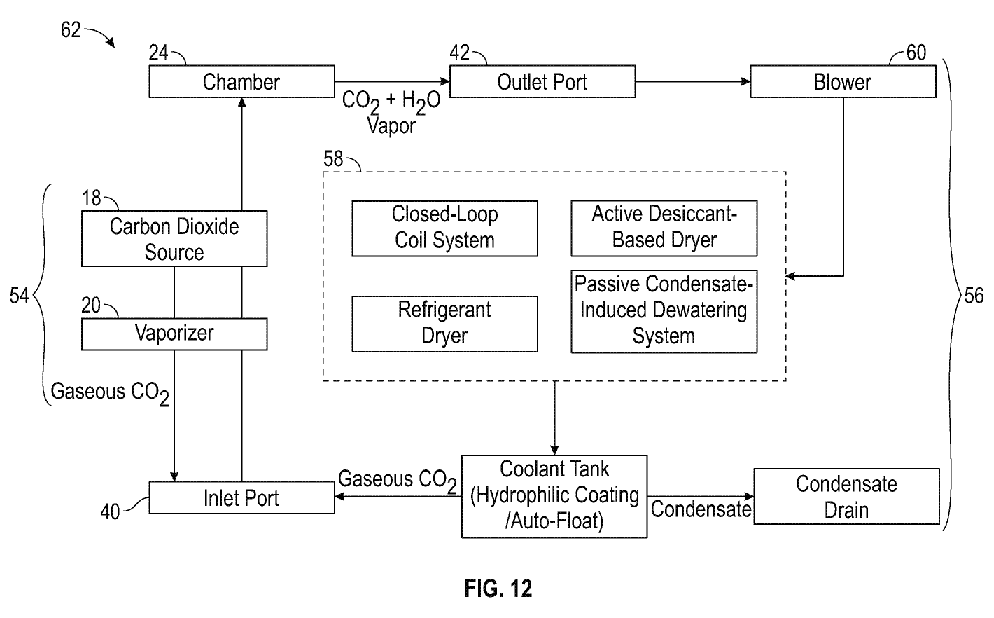

Referring to FIG. 12, a schematic diagram of a closed-loop gas circulation system 62 of the apparatus 16 is illustrated. The closed-loop gas circulation system 62 may be configured to circulate carbon dioxide gas and control relative humidity within the chamber 24 during the carbonation treatment process. The closed-loop gas circulation system 62 may include a carbon dioxide supply path 54 from the carbon dioxide source 18 through the vaporizer 20 to the inlet port 40 of the chamber 24, and a closed loop recirculation path 56 from the outlet port 42 through a dehumidification stage 58 and returning to the inlet port 40. The closed-loop gas circulation system 62 may comprise a gas circulation pathway whereby carbon dioxide gas is drawn from the chamber 24 through the at least one outlet port 42, passed through the dehumidification stage 58 to remove excess water vapor, and returned to the chamber 24 through the at least one inlet port 40. The closed-loop configuration may maintain the pressurized carbon dioxide atmosphere within the chamber 24 while simultaneously controlling relative humidity levels, thereby avoiding the need to vent and replace carbon dioxide gas during humidity adjustment.

The closed-loop gas circulation system 62 may further comprise a dehumidification stage 58 configured to remove excess water vapor from the circulating carbon dioxide gas. The dehumidification stage 58 may comprise one or more dehumidification options. In some aspects, the dehumidification stage 58 may comprise a closed-loop coil system in which a mixture of carbon dioxide and water vapor in gaseous form may be passed through the coil. In other aspects, the dehumidification stage 58 may comprise an active desiccant-based dryer configured to remove water vapor from the circulating gas stream. In further aspects, the dehumidification stage 58 may comprise a refrigerant dryer. In still further aspects, the dehumidification stage 58 may comprise a passive condensate-induced dewatering system. The dehumidification stage 58 may integrate with the closed-loop gas circulation system 62 to remove water vapor generated during the exothermic carbonation reaction, thereby maintaining relative humidity within the chamber 24 at a desired level throughout the treatment cycle.

In some aspects, the closed-loop coil system of the dehumidification stage 58 may include a coolant tank. The mixture of carbon dioxide and water vapor in gaseous form may be reserved in the coolant tank. The coolant tank may include a lining having a hydrophilic coating to facilitate collection of condensed water within the coolant tank. The coolant tank may further include an auto-float configured to detect condensed water levels within the coolant tank. The auto-float may enable draining of condensed water from the coolant tank without purging carbon dioxide gas from the system.

The combination of pressurized carbon dioxide gas circulation and active humidity control within the closed-loop gas circulation system 62 may optimize carbonation reaction conditions by maintaining carbon dioxide concentration and relative humidity within predetermined ranges throughout the treatment cycle. The closed-loop gas circulation system 62 of the present disclosure is fundamentally different from prior art approaches that rely on open-loop gas systems, passive humidity control using desiccants such as silica gel placed within the treatment vessel, or desiccation loops that may not maintain pressurized conditions during humidity adjustment.

In other aspects, the apparatus 16 may not be configured with a closed-loop gas circulation system 62, but may instead be manually controlled based on sensor readings provided by the controller 34 in connection with the plurality of sensors. In such aspects, the controller 34 may monitor treatment time, pressure, temperature, and relative humidity within the chamber 24 via the plurality of sensors and display the treatment time, pressure, temperature, and relative humidity data to an operator via the display or user interface. The operator may manually adjust treatment time, pressure, temperature, and relative humidity based on the sensor readings displayed by the controller 34. In other aspects, the apparatus 16 may be configured with the closed-loop gas circulation system 62 and the automatic control components, but may also include a manual override capability that enables an operator to transition from automatic control to manual control of treatment time, pressure, temperature, and relative humidity. The manual override capability may serve as a fail-safe feature in the event of a malfunction or failure of the closed-loop gas circulation system 62 or the automatic control components. In the event of a malfunction or failure of the closed-loop gas circulation system 62 or the automatic control components, the operator may transition to manual control of treatment time, pressure, temperature, and relative humidity based on the sensor readings provided by the controller 34, thereby enabling the carbonation treatment process to continue without interruption. The fail-safe manual control capability may prevent loss of a treatment batch and may reduce downtime associated with equipment failures.

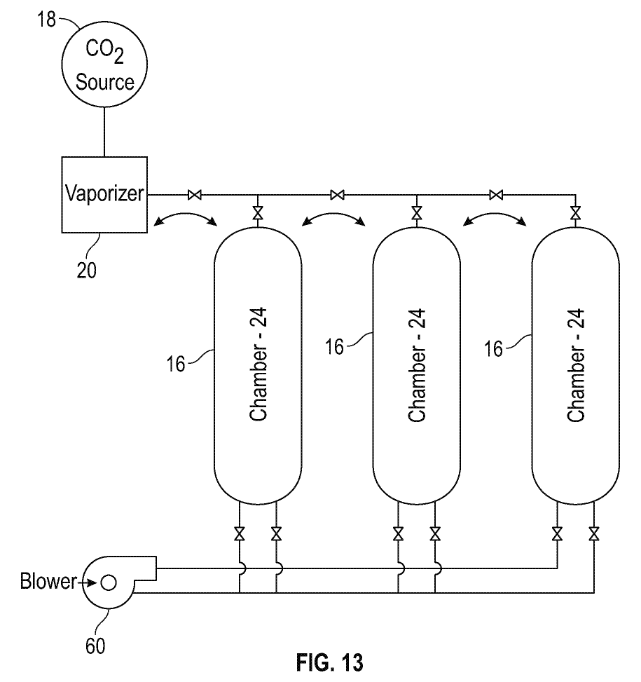

Referring to FIG. 13, a schematic diagram of a daisy-chain array configuration of multiple apparatuses 16 is illustrated. The daisy-chain array configuration may include multiple chambers 24, each forming part of a respective apparatus 16, fluidly interconnected through upper and lower manifolds with valves enabling selective control of carbon dioxide gas flow to and from individual chambers 24 within the array. A carbon dioxide source 18 and vaporizer 20 may supply carbon dioxide gas to the multiple chambers 24 through the upper manifold, and a blower may circulate carbon dioxide gas through the chambers 24 via the lower manifold.

The daisy-chain array configuration may enable multi-staged pressurization, whereby carbon dioxide gas expelled from a first apparatus 16 at a first pressure may be directed to a second apparatus 16 operating at a lower pressure. This cascading pressure arrangement may enable sequential utilization of the carbon dioxide gas across multiple treatment stages before the gas is exhausted, thereby reducing overall carbon dioxide consumption and improving operational efficiency for large-scale commercial applications.

In some aspects, the system 10 may include a pressurized holding tank fluidly connected to the at least one outlet port 42 of the treatment tank 22. The pressurized holding tank may store recovered carbon dioxide gas at a pressure suitable for reintroduction into a treatment tank 22 during a subsequent treatment cycle or for transfer to another apparatus 16 operating at a lower pressure in the daisy-chain array configuration. The controller 34 may be configured to monitor the pressure and volume of carbon dioxide gas within the pressurized holding tank and to automatically direct recovered gas to the appropriate treatment tank 22 based on the operating pressures and treatment schedules of the apparatuses 16 in the system 10. The integration of the pressurized holding tank with the daisy-chain array configuration may create a comprehensive carbon dioxide management system that minimizes waste of carbon dioxide gas and reduces operating costs for large-scale commercial applications.

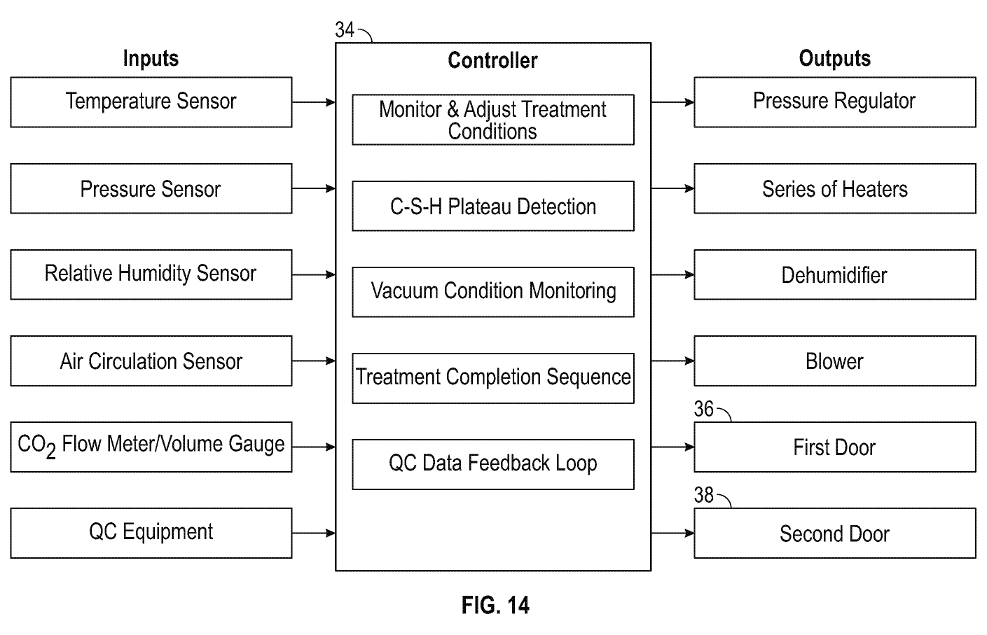

Referring to FIG. 14, a block diagram of the controller 34 of the apparatus 16 is illustrated. The controller 34 may be configured to operate with the plurality of sensors to maintain the temperature, pressure, circulation of carbon dioxide gas, and relative humidity inside the treatment tank 22 within a pre-defined range. The controller 34 may monitor the pressure of the carbon dioxide gas and temperature and relative humidity and air circulation inside the treatment tank 22 via the plurality of sensors. The controller 34 may adjust the pressure and temperature and relative humidity and air circulation inside the treatment tank 22 until a predetermined condition is met. In some aspects, the controller 34 may display the pressure, temperature, treatment time, and relative humidity inside the chamber 24 on a display or user interface to enable an operator to monitor the treatment conditions in real time. In other aspects, the controller 34 may automatically control the pressure, temperature, treatment time, and relative humidity inside the chamber 24 based on predetermined algorithms or treatment logic without requiring operator intervention. In some aspects, the predetermined condition may comprise a treatment time. In other aspects, the predetermined condition may comprise a pressure of an interior of the chamber 24. In further aspects, the predetermined condition may comprise a temperature of the interior of the chamber 24. In still further aspects, the predetermined condition may comprise a relative humidity of the interior of the chamber 24. In yet further aspects, the predetermined condition may comprise a circulation of carbon dioxide gas within the interior of the chamber 24. In some aspects, the predetermined condition may comprise combinations of treatment time, pressure, temperature, relative humidity, and circulation of carbon dioxide gas.

The controller 34 may be configured to transmit control signals to physical components of the apparatus 16 and system 10 to effectuate changes in the treatment conditions within the chamber 24. In some aspects, the controller 34 may transmit a control signal to a pressure regulator to increase or decrease the pressure of carbon dioxide gas within the chamber 24. In other aspects, the controller 34 may transmit a control signal to a series of heaters to increase or decrease the temperature within the chamber 24. In further aspects, the controller 34 may transmit a control signal to the at least one dehumidifier to increase or decrease the rate of water vapor removal from the chamber 24. In still further aspects, the controller 34 may transmit a control signal to a blower, compressor, purge apparatus, or vacuum system to increase or decrease the rate of gas circulation within the chamber 24. In yet further aspects, the controller 34 may transmit control signals to the first door 36 and the second door 38 to open or close the respective doors during loading and unloading operations. In other aspects, the controller 34 may transmit a control signal to the vaporizer 20 to increase or decrease the rate of conversion of liquid carbon dioxide to gaseous carbon dioxide for introduction into the chamber 24. The control signals transmitted by the controller 34 may cause physical actuation of the apparatus 16 components to adjust the treatment environment within the chamber 24 in real time based on the sensor data received from the plurality of sensors. In some aspects, the controller 34 may automatically transmit the control signals based on predetermined algorithms or treatment logic. In other aspects, the controller 34 may present the sensor data to an operator via a display or user interface, and the operator may manually direct the controller 34 to transmit the control signals to adjust the treatment conditions. In further aspects, the controller 34 may automatically transmit certain control signals while presenting other sensor data to the operator for manual decision-making.

In some aspects, the controller 34 may be configured for at-station monitoring, wherein the display or user interface is positioned locally adjacent to the apparatus 16 to enable an operator to monitor and control the treatment conditions while physically present at the apparatus 16. In other aspects, the controller 34 may be configured for remote monitoring, wherein the controller 34 is communicatively connected to a networked device such as a phone, computer, tablet, smart device, or other remote computing device, enabling an operator to monitor and control the apparatus 16 from a location remote from the chamber 24. In further aspects, the controller 34 may be configured for both at-station and remote monitoring, enabling an operator to transition between local and remote control based on operational requirements. The remote monitoring capability may enable a single operator to monitor multiple apparatuses 16 simultaneously from a central control location, which may improve operational efficiency for large-scale commercial applications involving multiple treatment tanks 22 or daisy-chain array configurations.

The controller 34's monitoring and adjustment of treatment conditions within the chamber 24 may effectuate a physical transformation of the RCA during the carbonation treatment process. The carbonation reaction controlled by the controller 34 may convert calcium hydroxide (Ca(OH)₂) within the residual cement paste of the RCA to calcium carbonate (CaCO₃), thereby physically altering the mineral composition, pore structure, and mechanical properties of the RCA. The treated RCA exiting the treatment tank 22 through the second opening 28 may have measurably different physical and chemical characteristics than the untreated RCA loaded into the treatment tank 22 through the first opening 26, including increased compressive strength, reduced water uptake, reduced alkalinity, and increased specific gravity. The controller 34's real-time monitoring and adjustment of pressure, temperature, relative humidity, and gas circulation within the chamber 24 may directly control the rate and extent of this physical transformation, ensuring that the carbonation reaction proceeds to the desired endpoint while preserving the structural integrity of the C-S-H minerals within the RCA.

The controller 34 may be configured to modify treatment variables based on input feedstock properties of the RCA to be treated. In some aspects, the input feedstock properties may include residual paste content of the RCA. In other aspects, the input feedstock properties may include residual mortar content of the RCA. In further aspects, the input feedstock properties may include aggregate crush value (ACV) of the RCA. In still further aspects, the input feedstock properties may include specific gravity of the RCA. In yet further aspects, the input feedstock properties may include moisture content of the RCA. In some aspects, the input feedstock properties may include Los Angeles (LA) abrasion value of the RCA. The controller 34 may adjust treatment parameters including pressure, temperature, relative humidity, treatment time, and carbon dioxide gas circulation based on the input feedstock properties to achieve consistent carbonation treatment results.

The carbonation reaction between carbon dioxide and calcium hydroxide present in the residual cement paste of the RCA is exothermic and produces heat and water as a byproduct. The water produced during the carbonation reaction may be in the form of a vapor mixed within the chamber 24. The controller 34 may be configured to monitor temperature build, humidity build, and pressure drop within the chamber 24 during the carbonation treatment process. These monitored parameters may provide insight into the progress and extent of the carbonation reaction occurring within the residual cement paste of the RCA. The residual cement paste of the RCA may include calcium hydroxide (Ca(OH)₂) and calcium silicate hydrate (C-S-H). Calcium hydroxide may be converted to calcium carbonate during the carbonation treatment process, which may improve the mechanical properties of the RCA. C-S-H is a hard mineral present in the cement paste, and conversion of C-S-H during the carbonation treatment process may be undesirable. The controller 34 may be configured to determine when to stop the carbonation treatment process based on the monitored temperature build, humidity build, and pressure drop, and may be configured to terminate the carbonation treatment process after the calcium hydroxide has been converted to calcium carbonate and before conversion of C-S-H begins.

In other aspects, the controller 34 may detect a plateau condition within the chamber 24 based on stabilization of temperature build, humidity build, and pressure drop. The plateau condition may indicate the transition from beneficial calcium hydroxide carbonation to undesirable C-S-H conversion. In some aspects, the controller 34 may automatically terminate the carbonation treatment process upon detection of the plateau condition to prevent conversion of C-S-H, without requiring operator intervention. In other aspects, the controller 34 may detect the plateau condition and provide an alert or notification to an operator via the display or user interface, and the operator may manually terminate the carbonation treatment process based on the information provided by the controller 34. In further aspects, the controller 34 may be configured to automatically terminate the carbonation treatment process upon detection of the plateau condition unless the operator overrides the automatic termination. This C-S-H protection monitoring capability represents a significant advancement over prior art carbonation approaches. Prior art systems may monitor general process parameters such as pressure and temperature, but do not specifically monitor for the plateau condition that indicates the transition from beneficial calcium hydroxide carbonation to undesirable C-S-H conversion.

The controller 34 may be configured to control treatment time to ensure adequate carbonation of the RCA without degrading favorable minerals, including C-S-H, in the cement paste. In some aspects, the RCA may be held in the chamber 24 with air movement and an air-drying process ongoing for a set period of time. The treatment time may be selected based on the input feedstock properties of the RCA and the treatment conditions within the chamber 24. In some aspects, the treatment time may be adjusted based on real-time monitoring of temperature, humidity, and pressure within the chamber 24 by the controller 34.

The controller 34 may be configured to provide active humidity control for maintaining relative humidity within the chamber 24 at a set range during the carbonation treatment process. In some aspects, the apparatus 16 may be configured to include means of controlling internal moisture and relative humidity at fixed conditions. In other aspects, the apparatus 16 may be configured to include means of controlling internal moisture and relative humidity within a range of conditions. Relative humidity control may be passive and modified by manual control. In other aspects, relative humidity control may be automatic and controlled by the controller 34 within preset conditions. In further aspects, the controller 34 may monitor relative humidity within the chamber 24 and display the relative humidity data to an operator, and the operator may manually adjust the dehumidifier or other humidity control equipment based on the displayed data. The controller 34 may operate the at least one dehumidifier to remove excess water vapor from the chamber 24 during the carbonation treatment process. In some aspects, the controller 34 may operate the series of heaters positioned inside the plurality of outer ducts to adjust temperature within the chamber 24, which may affect relative humidity conditions. The combination of pressure and maintained relative humidity within the chamber 24 may facilitate the carbonation treatment process while avoiding buildup of carbonic acid within the chamber 24.

During the carbonation treatment process, the RCA within the chamber 24 may consume and convert carbon dioxide gas through calcium carbonate mineralization. In some aspects, treatment at approximately 150psi after approximately 8 to 12 hours may cause the chamber 24 to transition into a vacuum condition. The vacuum condition may occur as the RCA consume and convert carbon dioxide gas through calcium carbonate mineralization during the carbonation reaction, thereby reducing the pressure within the chamber 24 below atmospheric pressure. The controller 34 may be configured to monitor pressure conditions within the chamber 24 and detect the transition to vacuum conditions during extended treatment cycles. In some aspects, the controller 34 may use the transition to vacuum conditions as an indicator that carbonation of the RCA is substantially complete. The transition to vacuum conditions may indicate that a substantial portion of the available carbon dioxide gas within the chamber 24 has been consumed through calcium carbonate mineralization within the RCA, and that the rate of carbonation has diminished. The controller 34 may be configured to initiate a treatment completion sequence upon detection of the vacuum condition, including depressurization of the chamber 24, opening of the second door 38, and unloading of the treated RCA through the second opening 28. In other aspects, the controller 34 may detect the transition to vacuum conditions and provide an alert or notification to an operator, and the operator may manually initiate the treatment completion sequence based on the information provided by the controller 34. The use of the vacuum condition as a treatment endpoint indicator may provide a direct, real-time measurement of carbonation progress that is independent of predetermined time-based treatment schedules, enabling the controller 34 to optimize treatment duration for each batch based on actual carbonation uptake rather than estimated treatment times.

The apparatus 16 may be configured to monitor and avoid buildup of carbonic acid within the chamber 24 during the carbonation treatment process. Carbonic acid may form when carbon dioxide gas dissolves in water vapor present within the chamber 24. The controller 34 may be configured to monitor conditions within the chamber 24 that may lead to carbonic acid formation, including relative humidity levels and carbon dioxide concentration. The combination of pressure and maintained relative humidity within the chamber 24 may facilitate the carbonation treatment process while avoiding buildup of carbonic acid. In some aspects, the apparatus 16 may include carbonic acid monitoring equipment configured to detect carbonic acid levels within the chamber 24. The controller 34 may adjust treatment conditions, including relative humidity and temperature, to minimize carbonic acid formation during the carbonation treatment process.

The system 10 and apparatus 16 may include quality control (QC) equipment configured to characterize the RCA prior to the carbonation treatment process. In some aspects, the QC equipment may include testing apparatus configured to measure residual mortar content (RMC) of the untreated RCA. Residual mortar content refers to the proportion of residual cement paste and mortar adhered to the original aggregate particles within the RCA. In other aspects, the QC equipment may include testing apparatus configured to measure water uptake capacity of the untreated RCA. The water uptake capacity measurement may indicate the porosity and condition of the untreated RCA prior to treatment. The controller 34 may be configured to receive QC data from the QC equipment and adjust treatment parameters based on the measured properties of the untreated RCA. In some aspects, the controller 34 may be configured to automatically adjust treatment parameters based on the QC data received from the QC equipment, without requiring operator intervention. For example, the controller 34 may automatically increase treatment pressure or extend treatment time for RCA having higher residual mortar content, which may require more extensive carbonation treatment. The controller 34 may automatically decrease treatment pressure or reduce treatment time for RCA having lower residual mortar content or higher initial specific gravity, which may indicate less residual cement paste available for carbonation. The controller 34 may further automatically adjust relative humidity set points based on the measured moisture content of the untreated RCA. In other aspects, the controller 34 may receive the QC data and display the QC data and corresponding treatment parameters to an operator via the display or user interface, and the operator may manually adjust treatment parameters including pressure, treatment time, and relative humidity based on the QC data provided by the controller 34. In further aspects, the controller 34 may receive the QC data and provide recommended treatment parameter adjustments to the operator via the display or user interface, and the operator may accept, modify, or override the recommended adjustments before the controller 34 implements the adjustments. This feedback loop between QC measurement and controller adjustment — whether performed automatically by the controller 34 or manually by the operator based on information provided by the controller 34 — may enable the system 10 and apparatus 16 to optimize treatment conditions for each batch of RCA, thereby improving treatment consistency and reducing waste of carbon dioxide gas and energy.

The system 10 and apparatus 16 may include quality assurance (QA) equipment configured to verify the properties of the treated RCA following the carbonation treatment process. In some aspects, the QA equipment may include a wet attrition testing apparatus configured to measure the abrasion resistance of the treated RCA. The wet attrition testing apparatus may comprise a rotating drum containing steel balls or similar abrasive media and water, wherein a sample of treated RCA is tumbled within the rotating drum for a predetermined period to measure degradation and mass loss under wet abrasive conditions. The wet attrition test may evaluate the durability of the treated RCA under conditions simulating wear and weathering. In some aspects, the QA equipment may include the weighing scales positioned on the first conveyance device 12 and the second conveyance device 14. The weighing scales may be configured to measure the weight of untreated RCA prior to treatment and the weight of treated RCA following treatment. A comparison of the pre-treatment weight and the post-treatment weight may provide an indication of the degree of calcium carbonate mineralization achieved during the carbonation treatment process, as the formation of calcium carbonate minerals within the pores of the RCA may increase the overall mass of the treated RCA. The controller 34 may be configured to receive weight data from the weighing scales and calculate the weight increase as a quality assurance metric for verifying the effectiveness of the carbonation treatment.

In some aspects, the QA equipment may include testing apparatus configured to measure post-treatment water uptake capacity, specific gravity, aggregate crush value (ACV), and leachate pH of the treated RCA. The leachate pH measurement may be particularly relevant for applications where the treated RCA will be in contact with soil or groundwater, such as pipe bedding, engineered backfill, and base course applications. In further aspects, the QA equipment may include an abrasion testing apparatus configured to evaluate the resistance of treated RCA to mechanical degradation under controlled conditions. The controller 34 may be configured to receive QA data from the QA equipment and compare the measured post-treatment properties against predetermined quality thresholds for the intended end-use application. In some aspects, the controller 34 may display the QA data to an operator via the display or user interface to enable the operator to evaluate whether the treated RCA meets the required specifications for the intended application. In other aspects, the controller 34 may automatically flag treated RCA batches that do not meet the predetermined quality thresholds and may adjust treatment parameters for subsequent batches based on the QA data to improve treatment outcomes. The integration of the QA equipment with the controller 34 may create a closed-loop quality management system in which post-treatment QA data informs and optimizes the treatment parameters for subsequent treatment cycles.

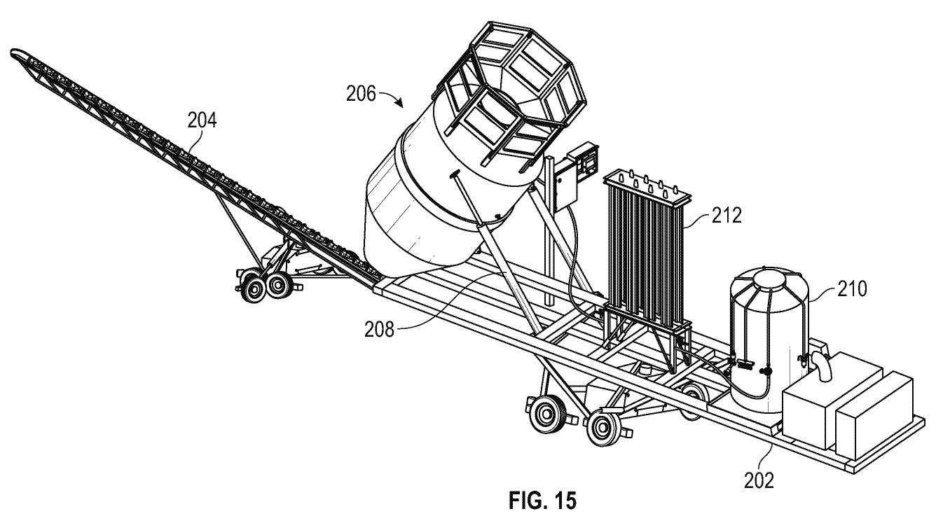

Referring to FIG. 15, a perspective view of the apparatus 206 in a mobile trailer-mounted configuration is illustrated. The system 200 may comprise an apparatus 206 mounted on a trailer chassis 202. In particular, the apparatus 206 may be the apparatus 16 illustrated in FIGS. 2, 3 in a vertical or horizontal orientation configuration. The trailer chassis 202 may be configured to transport the apparatus 206 between different work sites, such as demolition sites, crushing facilities, highway reconstruction projects, interstate rehabilitation projects, airport runway replacement projects, and building demolition sites. The portable configuration may enable crushed concrete to be treated on-site and immediately reused in the construction project, thereby eliminating the need to transport untreated RCA to a separate treatment facility and reducing transportation costs, logistics, and associated carbon emissions.

The trailer chassis 202 may support the apparatus 206, a carbon dioxide source 210, and a vaporizer 212. In particular, the carbon dioxide source 210 and vaporizer 212 may be the same as those described above with respect to FIG. 1. In some aspects, the trailer chassis 202 may be configured to carry the entire system 200 as a self-contained, portable unit, including the apparatus 206, the carbon dioxide source 210, and the vaporizer 212. The integration of all system components onto a single trailer chassis 202 may enable the entire system 200 to be transported to a work site and deployed for on-site carbonation treatment without requiring separate transportation of individual components. In other aspects, the system 200 may be distributed across multiple trailer chassis, with the apparatus 206 on a first trailer chassis and the carbon dioxide source 210 and the vaporizer 212 on a second trailer chassis.

Jacks 208 may be positioned at one or more ends of the trailer chassis 202 and may be configured to tilt the apparatus 206 to facilitate gravity-assisted loading and unloading of RCA. In some aspects, the jacks 208 may be hydraulically operated by a controller to provide controlled tilting of the apparatus 206 during unloading operations. A first conveyance device (not shown) may extend towards the apparatus 206 for transporting untreated RCA into the system 200. A second conveyance device 204 may extend from the apparatus 206 for transporting treated RCA away from the system 200. In some aspects, the first conveyance device and/or the second conveyance device 204 may be incorporated into the trailer chassis 202 for convenient transport of RCA into and away from the system 200.

The trailer chassis 202 may be configured to support the apparatus 206 in either a vertical orientation and/or a horizontal orientation. The horizontal orientation may be particularly suited for transport, as the treatment tank 22 may be positioned along the length of the trailer chassis 202 for improved stability during transit and to comply with height restrictions on roadways. The vertical orientation may be particularly suited for on-site operation, as the vertical positioning of the treatment tank 22 may enable gravity-assisted loading of untreated RCA through the first opening at the upper portion and gravity-assisted unloading of treated RCA through the second opening at the lower portion. In some aspects, the apparatus 206 may be configured to transition between the vertical orientation and the horizontal orientation using hydraulic lifts, pivoting mechanisms, or tilting mechanisms incorporated into the trailer chassis 202. For example, the apparatus 206 may be transported between work sites in the horizontal orientation for improved stability during transit, and then transitioned to the vertical orientation upon arrival at the work site for gravity-assisted loading and unloading during operation. The ability to transition between orientations on the trailer chassis 202 may provide operational flexibility and enable the apparatus 206 to be optimized for both transport and on-site treatment conditions.

A number of implementations have been described. Nevertheless, it will be understood that various modifications may be made without departing from the spirit and scope of the disclosure. Accordingly, other implementations are within the scope of the following claims.

1. An apparatus for carbonation of recycled concrete aggregates (RCA), the apparatus comprising:
a treatment tank comprising a hermetically sealable chamber configured to hold recycled concrete aggregates during a carbonation treatment process, the chamber comprising:
a) a first portion having a first tapered frustoconical sidewall with a first opening therein, the first opening configured to receive untreated RCA into the chamber;
b) a second portion having a second tapered frustoconical sidewall with a second opening therein, the second opening configured to expel treated RCA out of the chamber;
c) a first hermetically sealable door associated with the first opening; and
d) a second hermetically sealable door associated with the second opening;
e) at least one inlet port positioned on an exterior wall of the chamber and configured to fluidly connect the treatment tank to a carbon dioxide source for supplying carbon dioxide gas in a gaseous state to pressurize the chamber and accelerate carbonation of the recycled concrete aggregates within the chamber;
f) at least one outlet port positioned on the exterior wall of the chamber and configured to remove excess carbon dioxide gas from the treatment
tank; and
g) internal components mounted within the chamber and configured to distribute the carbon dioxide gas throughout the treatment tank to expose the recycled concrete aggregates therein for carbonation treatment;
a plurality of sensors configured to measure at least temperature, pressure, and relative humidity inside the treatment tank;
a controller configured to monitor and provide for adjustment of treatment conditions within the treatment tank based on data received from the plurality of sensors;
controller configured to detect a plateau condition within the chamber based on stabilization of temperature build, humidity build, and pressure drop; and
the controller configured to provide for termination of the carbonation treatment process upon detection of the plateau condition to prevent conversion of calcium silicate hydrate (C-S-H) within the RCA.

2. The apparatus of claim 1, wherein the internal components comprise a plurality of ducts including a central duct mounted in the chamber, a plurality of outer ducts mounted in the chamber, and a plurality of cross ducts fluidly connecting the central duct to the plurality of outer ducts.

3. The apparatus of claim 1, wherein the at least one inlet port comprises a valve purge opening configured to enable nitrogen gas to be injected into the treatment tank to purge ambient air from the chamber before pressurization with carbon dioxide gas.

4. The apparatus of claim 1, further comprising a closed-loop gas circulation system comprising a gas circulation pathway configured to:
draw carbon dioxide gas from the chamber through the at least one outlet port;
pass the carbon dioxide gas through a dehumidification stage to remove excess water vapor; and
return the carbon dioxide gas to the chamber through the at least one inlet port;
wherein the closed-loop gas circulation system is configured to maintain a pressurized carbon dioxide atmosphere within the chamber while controlling relative humidity.

5. The apparatus of claim 1, wherein the controller is configured to:
transmit control signals to physical components of the apparatus to effectuate changes in the treatment conditions within the chamber;
the control signals comprising at least one of:
a) a signal to a pressure regulator to adjust pressure of carbon dioxide gas within the chamber;
b) a signal to a series of heaters to adjust temperature within the chamber;
c) a signal to at least one dehumidifier to adjust a rate of water vapor removal from the chamber; and
d) a signal to a blower to adjust a rate of air circulation within the chamber.

6. The apparatus of claim 1, wherein the controller is configured to:
use a transition to vacuum conditions within the chamber as an indicator that carbonation of the recycled concrete aggregates is substantially complete; and
upon detection of the vacuum condition provide for termination of treatment.

7. The apparatus of claim 1, wherein at least one of the first hermetically sealable door and the second hermetically sealable door comprises:
an operable hatch comprising a hinged or pivoting closure mechanism configured to swing open and swing closed to seal the respective opening during pressurization, the operable hatch being hydraulically or pneumatically actuated for operation; or
a slide gate comprising a sliding closure mechanism that translates laterally or linearly to open and close the respective opening, the slide gate being hydraulically or pneumatically actuated for operation.

8. The apparatus of claim 1, wherein the chamber has a volume of at least 400 cubic feet and the treatment tank is configured to treat at least 10 tons of RCA per treatment cycle.

9. The apparatus of claim 1, wherein the controller is configured to maintain elevated pressure of carbon dioxide gas within the chamber during the carbonation treatment process and to provide for termination of the carbonation treatment process within approximately 4 to 12 hours based on monitored treatment conditions.

10. A system for carbonation of recycled concrete aggregates (RCA), the system comprising:
a first conveyance device configured to transport untreated RCA to the system;
a second conveyance device configured to transport treated RCA away from the system;
a vaporizer configured to convert liquid carbon dioxide from a carbon dioxide source into gaseous carbon dioxide for introduction into the treatment tank through at least one inlet port;
an apparatus positioned adjacent to the first conveyance device and the second conveyance device, the apparatus comprising:
a) a treatment tank;
b) the treatment tank comprising a hermetically sealable chamber;
c) the chamber having a first opening and a second opening;
d) the first opening comprising a first tapered frustoconical sidewall configured to direct untreated RCA from the first conveyance device into the chamber;
e) the second opening comprising a second tapered frustoconical sidewall configured to direct treated RCA from the chamber to the second conveyance device;
f) the first opening and the second opening each having a hermetically sealable door;
g) the at least one inlet port configured to fluidly connect the treatment tank to a carbon dioxide source for supplying carbon dioxide gas in a gaseous state to pressurize the chamber;
h) at least one outlet port configured to remove excess carbon dioxide gas from the treatment tank;
i) internal components mounted within the chamber and configured to distribute the carbon dioxide gas throughout the treatment tank;
j) a controller configured to monitor and to provide for adjustment of pressure, temperature, and relative humidity within the chamber; and
k) a support assembly configured to suspend the treatment tank at a designated position relative to the first conveyance device and the second conveyance device, the first opening positioned adjacent to the first conveyance device and the second opening positioned adjacent to the second conveyance device
wherein the chamber pressurized with carbon dioxide gas is configured to accelerate carbonation of the recycled concrete aggregates within the chamber as compared to ambient carbonation.

11. The system of claim 10, wherein the chamber has a volume of at least 400 cubic feet and the system is configured to treat at least 10 tons of RCA per treatment cycle.

12. The system of claim 10, further comprising at least one additional apparatus fluidly connected to the at least one outlet port of the apparatus in a daisy-chain array configuration, the daisy-chain array configuration enabling multi-staged pressurization whereby carbon dioxide gas expelled from the apparatus at a first pressure is directed to the at least one additional apparatus operating at a lower pressure.

13. The system of claim 10, wherein the treatment tank is mounted on a trailer chassis for mobile use;
the trailer chassis configured to transport the carbon dioxide source, the vaporizer, and the treatment tank as a self-contained portable unit to a job site; and
the support assembly of the treatment tank further comprising jacks positioned at one or more ends of the trailer chassis and configured to tilt the treatment tank to facilitate unloading of treated RCA from the chamber through the second opening.

14. The system of claim 10, wherein the controller is configured to:
detect a plateau condition within the chamber based on stabilization of temperature build, humidity build, and pressure drop; and
provide for termination of the carbonation treatment process upon detection of the plateau condition to prevent conversion of calcium silicate hydrate (C-S-H) within the RCA.

15. The system of claim 10, wherein the internal components comprise:
a plurality of ducts configured to distribute the pressurized carbon dioxide gas from the at least one inlet port through a central duct and outward through a plurality of cross ducts to a plurality of outer ducts;
wherein the plurality of ducts are configured to provide multiple gas delivery points throughout the chamber.

16. An apparatus for treating recycled concrete aggregates (RCA), the apparatus comprising:
a treatment tank comprising a hermetically sealable chamber configured to hold recycled concrete aggregates during a pressurized carbonation treatment process;
a first opening configured to receive untreated RCA into the chamber and a second opening configured to expel treated RCA from the chamber, each of the first opening and the second opening having a hermetically sealable door;
at least one inlet port and at least one outlet port positioned on an exterior wall of the chamber;
a closed-loop gas circulation system comprising a gas circulation pathway configured to draw carbon dioxide gas from the chamber through the at least one outlet port, pass the carbon dioxide gas through a dehumidification stage to remove excess water vapor, and return the carbon dioxide gas to the chamber through the at least one inlet port, the closed-loop gas circulation system configured to maintain a pressurized carbon dioxide atmosphere within the chamber while controlling relative humidity to optimize conditions for accelerated carbonation of the recycled concrete aggregates;
a plurality of sensors configured to measure at least pressure, temperature, and relative humidity within the chamber;
quality control equipment configured to measure at least one property of the untreated RCA prior to the carbonation treatment process; and
a controller configured to:
a) receive data from the plurality of sensors and the quality control equipment;
b) provide for adjustment of treatment parameters comprising pressure, treatment time, and relative humidity based on the measured property of the untreated RCA to control a rate of carbonation of the recycled concrete aggregates within the chamber;
c) monitor temperature build, humidity build, and pressure drop within the chamber during the carbonation treatment process; and
d) provide for termination of the carbonation treatment process based on the monitored temperature build, humidity build, and pressure drop to prevent conversion of calcium silicate hydrate (C-S-H) within the RCA;
wherein the chamber has a volume of at least 400 cubic feet and the system is configured to treat at least 10 tons of RCA per treatment cycle.

17. The apparatus of claim 16, further comprising:
the quality control equipment configured to measure at least one of residual mortar content, water uptake capacity, specific gravity, and moisture content of the untreated RCA; and
the controller configured to increase treatment pressure or extend treatment time for recycled concrete aggregates having higher residual mortar content and to decrease treatment pressure or reduce treatment time for recycled concrete aggregates having lower residual mortar content.

18. The apparatus of claim 16, wherein the dehumidification stage comprises at least one of a closed-loop coil system, an active desiccant-based dryer, a refrigerant dryer, and a passive condensate-induced dewatering system.

19. The apparatus of claim 16, further comprising a pressurized holding tank fluidly connected to the at least one inlet port and configured to store recovered carbon dioxide gas at a pressure suitable for reintroduction into the treatment tank during a subsequent treatment cycle.

20. The apparatus of claim 16, wherein the controller is configured to display treatment conditions including pressure, temperature, treatment time, and relative humidity within the chamber to an operator via a display or user interface for manual monitoring and adjustment of the treatment parameters, the display or user interface accessible locally adjacent to the apparatus or remotely via a networked device.
